(19) United States
(12) Patent Application Publication
(10) Pub. No.: US 2017/0341648 A1
(43) Pub. Date: Nov. 30, 2017

(54) AUTONOMOUS DRIVING CONTROL APPARATUS, DRIVING INFORMATION OUTPUT APPARATUS, FOOTREST, AUTONOMOUS DRIVING CONTROL METHOD, AND DRIVING INFORMATION OUTPUT METHOD

(71) Applicants: DENSO CORPORATION, Kariya-city, Aichi-pref. (JP); SOKEN, INC., Nishio-city, Aichi-pref. (JP)

(72) Inventors: Norio SANMA, Nishio-city (JP); Motoki TACHIIRI, Nishio-city (JP); Syunsuke SHIBATA, Nishio-shi (JP); Akira OKADA, Nishio-shi (JP); Hiroaki TAKEDA, Nishio-shi (JP); Sei IGUCHI, Kariya-shi, Aichi-pref. (JP)

(21) Appl. No.: 15/534,456

(22) PCT Filed: Dec. 1, 2015
(86) PCT No.: PCT/JP2015/005965

§ 371 Date: Jun. 8, 2017

(30) Foreign Application Priority Data
Dec. 9, 2014 (JP) 2014-248891
Aug. 31, 2015 (JP) 2015-171403

(51) Int. Cl. B60W 30/14; B60W 50/14; B60W 50/10

(52) U.S. Cl. CPC B60W 30/14; B60W 50/10; B60W 50/14

(57) ABSTRACT

An autonomous driving control apparatus that achieves autonomous driving by controlling a driving operation of a subject vehicle, based on a situation around the subject vehicle is provided. The autonomous driving control apparatus includes: a driving operation determination part that determines a detail of the driving operation of the subject vehicle, based on the situation; a driving operation control part that controls the driving operation in accordance with the detail; and a driving information output part that shifts a footrest portion of a footrest at a seat on a driver seat side of the subject vehicle by driving a driving part provided on the footrest, to output the detail as driving information. The driving information output part varies a frontward inclination angle in accordance with a level of acceleration or deceleration of the subject vehicle, to output the driving information.

### CROSS REFERENCE TO RELATED APPLICATIONS

The present application is based on Japanese Patent Application No. 2014-248891 filed on Dec. 9, 2014, and Japanese Patent Application No. 2015-171403 filed on Aug. 31, 2015, the disclosures of which are incorporated herein by reference.

### TECHNICAL FIELD

The present disclosure relates to a technology for autonomous driving of vehicle in accordance with a situation around the vehicle.

### BACKGROUND ART

In recent years, there has been developed a technology for realizing autonomous driving of a vehicle under which the vehicle is capable of maintaining a traveling lane and avoiding an obstacle while recognizing a surrounding situation. During autonomous driving, a computer mounted on the vehicle (hereinafter referred to as driving control apparatus) drives the vehicle in place of a driver. In this case, the driver often feels uncomfortable by a manner of driving of the driving control apparatus (such as cornering, course change for obstacle avoidance, and timing and level of acceleration and deceleration).

Technologies have been proposed to realize a manner of driving by the driving control apparatus closest to a manner of driving by an ordinary driver (for example, see Patent Literature 1).

### PRIOR ART LITERATURES

### Patent Literature

Patent Literature 1: JP 2014-218098 A

### SUMMARY OF INVENTION

Sufficient reduction of discomfort given to the driver during autonomous driving may be difficult even by use of the technologies currently proposed. This difficulty in reduction of discomfort may come from limitation to reduction of the difference between the manner of driving by the driver and the manner of driving by the autonomous control apparatus in a state that the manner of driving is variable in accordance with the surrounding situation and the individuality of the driver.

It is an object of the present disclosure to provide a technology capable of achieving autonomous driving of a vehicle without giving discomfort to a driver.

An autonomous driving control apparatus that achieves autonomous driving by controlling a driving operation of a subject vehicle, based on a situation around the subject vehicle, according to one example of the present disclosure, includes: a driving operation determination part that determines a detail of the driving operation of the subject vehicle, based on the situation around the subject vehicle; a driving operation control part that controls the driving operation of the subject vehicle in accordance with the detail determined of the driving operation; and a driving information output part that shifts a footrest portion of a footrest at a seat on a driver seat side of the subject vehicle by driving a driving part provided on the footrest, to output the detail determined of the driving operation as driving information.

A driving information output apparatus that is mounted on a subject vehicle capable of performing autonomous driving based on a situation around the subject vehicle, and outputs driving information about a detail of a driving operation during the autonomous driving to an occupant of the subject vehicle, according to another example of the present disclosure, includes: a driving information acquisition part that acquires the driving information from an autonomous driving controller that controls the driving operation of the subject vehicle during the autonomous driving; and a driving information output part that shifts a footrest portion of a footrest provided at a seat on a driver seat side of the subject vehicle by driving a driving part provided on the footrest to output the detail determined of the driving operation as the driving information.

A footrest on which an occupant sitting on a seat of a subject vehicle places a foot of the occupant, according to another example of the present disclosure, includes: a footrest portion on which the foot of the occupant is placed; and a driving part that shifts the footrest portion under control by the subject vehicle.

An autonomous driving control method achieving autonomous driving by controlling a driving operation of a subject vehicle, based on a situation around the subject vehicle, according to another example of the present disclosure, includes: a driving operation determination step that determines a detail of the driving operation of the subject vehicle based on the situation around the subject vehicle; a driving information output step that shifts a footrest portion of a footrest provided at a seat on a driver seat side of the subject vehicle to output the detail determined of the driving operation as driving information; and a driving operation control step that controls the driving operation of the subject vehicle in accordance with the detail determined of the driving operation.

A driving information output method that is applied to a subject vehicle capable of performing autonomous driving based on a situation around the subject vehicle, and outputs driving information about a detail of a driving operation during the autonomous driving to an occupant of the subject vehicle, according to another example of the present disclosure, includes: a driving information acquisition step that acquires the driving information; and a driving information output step that shifts a footrest portion of a footrest provided at a seat on a driver seat side of the subject vehicle to output the detail, which is determined, of the driving operation as the driving information.

According to the autonomous driving control apparatus, the driving information output apparatus, the autonomous driving control method, and the driving information output method, the footrest portion of the footrest provided at a side of a driver seat of the vehicle is shifted to output the detail of the driving operation of the vehicle as the driving information when the detail of the driving operation is determined based on the situation around the vehicle.

According to this configuration, it may be possible for a driver to recognize the detail of the autonomous driving operation beforehand. Accordingly, the driver does not feel uncomfortable during the autonomous driving of the vehicle even when the manner of driving by the autonomous driving is different from the manner of driving by the driver.

According to the footrest of the present disclosure, the footrest portion on which the foot of the occupant is placed is shifted under control by the vehicle. In this case, the driver recognizes the detail of the autonomous driving operation based on a shift of the footrest portion in accordance with the detail of the autonomous driving operation. Accordingly, the driver does not feel uncomfortable during the autonomous driving of the vehicle.

### BRIEF DESCRIPTION OF DRAWINGS

The above and other aspects, features and advantages of the present disclosure will become more apparent from the following detailed description made with reference to the accompanying drawings. In the drawings:

FIG. 1 is a view explaining a subject vehicle on which an autonomous driving control apparatus according to a present embodiment is mounted;

FIG. 2 is a block diagram showing an internal configuration of the autonomous driving control apparatus according to the present embodiment;

FIG. 3A is a view explaining a footrest mounted on the subject vehicle according to the present embodiment;

FIG. 3B is a view explaining the footrest mounted on the subject vehicle according to the present embodiment;

FIG. 4 is a flowchart showing a first half of an autonomous driving control process executed by the autonomous driving control apparatus according to the present embodiment;

FIG. 5 is a flowchart showing a second half of the autonomous driving control process;

FIG. 6A is a view illustrating an example of a notice time for issuing a notice about a detail of an autonomous driving operation from the autonomous driving control apparatus according to the present embodiment, and a start time of the autonomous driving operation, based on a collision time;

FIG. 6B is a view illustrating an example of a deceleration start;

FIG. 6C is a view illustrating an example of a deceleration notice;

FIG. 7A is a view illustrating an example of a notice time for issuing a notice about a detail of the autonomous driving operation from the autonomous driving control apparatus according to the present embodiment, and a start time of the autonomous driving operation, based on a distance to an object on a map;

FIG. 7B is a view illustrating an example of a notice time for issuing a notice about a detail of the autonomous driving operation from the autonomous driving control apparatus according to the present embodiment, and a start time of the autonomous driving operation, based on a distance to an object on the map;

FIG. 8A is a view explaining an example of a notice about a detail of the autonomous driving operation, issued by driving a footrest by the autonomous driving control apparatus according to the present embodiment;

FIG. 8B is a view explaining an example of a deceleration notice;

FIG. 8C is a view explaining an example of a leftward steering notice;

FIG. 8D is a view explaining an example of a rightward steering notice;

FIG. 9A is a view explaining an example of a notice about a detail of the autonomous driving operation, issued by varying a frontward inclination angle θ of a footrest portion of the footrest in accordance with acceleration of the subject vehicle;

FIG. 9B is a view explaining an example of the frontward inclination angle θ;

FIG. 9C is a view explaining an example of a notice about a detail of the autonomous driving operation, issued by varying the frontward inclination angle θ of the footrest portion of the footrest in accordance with acceleration of the subject vehicle;

FIG. 10A is a view explaining a different example varying the frontward inclination angle θ of the footrest portion of the footrest in accordance with acceleration of the subject vehicle;

FIG. 10B is a view explaining a different example varying the frontward inclination angle θ of the footrest portion of the footrest in accordance with acceleration of the subject vehicle;

FIG. 11A is a view explaining an example oscillating the frontward inclination angle θ of the footrest portion of the footrest in accordance with acceleration of the subject vehicle;

FIG. 11B is a view explaining an example oscillating the frontward inclination angle θ of the footrest portion of the footrest in accordance with acceleration of the subject vehicle;

FIG. 11C is a view explaining an example oscillating the frontward inclination angle θ of the footrest portion of the footrest in accordance with acceleration of the subject vehicle;

FIG. 12A is a view explaining an example of a notice about a detail of the autonomous driving operation, issued by varying the frontward inclination angle θ of the footrest portion of the footrest in accordance with a vehicle speed of the subject vehicle;

FIG. 12B is a view explaining an example of a notice about a detail of the autonomous driving operation, issued by varying the frontward inclination angle θ of the footrest portion of the footrest in accordance with the vehicle speed of the subject vehicle;

FIG. 12C is a view explaining an example of a notice about a detail of the autonomous driving operation by varying the frontward inclination angle θ of the footrest portion of the footrest in accordance with the vehicle speed of the subject vehicle;

FIG. 12D is a view explaining an example of a notice about a detail of the autonomous driving operation, issued by varying the frontward inclination angle θ of the footrest portion of the footrest in accordance with the vehicle speed of the subject vehicle;

FIG. 13A is a view explaining an example oscillating the frontward inclination angle θ of the footrest portion of the footrest in accordance with the vehicle speed of the subject vehicle;

FIG. 13B is a view explaining an example oscillating the frontward inclination angle θ of the footrest portion of the footrest in accordance with the vehicle speed of the subject vehicle;

FIG. 13C is a view explaining an example oscillating the frontward inclination angle θ of the footrest portion of the footrest in accordance with the vehicle speed of the subject vehicle;

FIG. 14A is a view explaining an example of a notice about a detail of the autonomous driving operation, issued by varying an transverse inclination angle φ of the footrest portion of the footrest in accordance with steering information on the subject vehicle;

FIG. 14B is a view explaining an example of a notice about a detail of the autonomous driving operation, issued by varying the transverse inclination angle φ of the footrest portion of the footrest in accordance with the steering information on the subject vehicle;

FIG. 14C is a view explaining an example of a notice about a detail of the autonomous driving operation, issued by varying the transverse inclination angle φ of the footrest portion of the footrest in accordance with the steering information on the subject vehicle;

FIG. 14D is a view explaining an example of a notice about a detail of the autonomous driving operation, issued by varying the transverse inclination angle φ of the footrest portion of the footrest in accordance with the steering information on the subject vehicle;

FIG. 14E is a view explaining an example of a notice about a detail of the autonomous driving operation, issued by varying the transverse inclination angle φ of the footrest portion of the footrest in accordance with the steering information on the subject vehicle;

FIG. 15A is a view explaining an example oscillating the transverse inclination angle φ of the footrest portion of the footrest in accordance with the steering information on the subject vehicle;

FIG. 15B is a view explaining an example oscillating the transverse inclination angle φ of the footrest portion of the footrest in accordance with the steering information on the subject vehicle;

FIG. 15C is a view explaining an example oscillating the transverse inclination angle φ of the footrest portion of the footrest in accordance with the steering information on the subject vehicle;

FIG. 16A is a view explaining a different example of a notice about a detail of the autonomous driving operation issued by driving the footrest;

FIG. 16B is a view explaining a different example of a notice about a detail of the autonomous driving operation issued by driving the footrest;

FIG. 16C is a view explaining a different example of a notice about a detail of the autonomous driving operation issued by driving the footrest;

FIG. 17A is a view explaining a further different example of a notice about a detail of the autonomous driving operation issued by driving the footrest;

FIG. 17B is a view explaining the further different example of a notice about a detail of the autonomous driving operation issued by driving the footrest;

FIG. 18A is a view explaining an example of a notice about a detail of the autonomous driving operation issued by driving a seat;

FIG. 18B is a view explaining an example of a notice about a detail of the autonomous driving operation issued by driving the seat; and

FIG. 19 is a view explaining an example of a request of override issued to a driver by oscillating the frontward inclination angle θ or the transverse inclination angle φ of the footrest portion of the footrest.

### DESCRIPTION OF EMBODIMENTS

An embodiment will be explained to describe contents of the disclosure of the present application described above.

### (Apparatus Configuration)

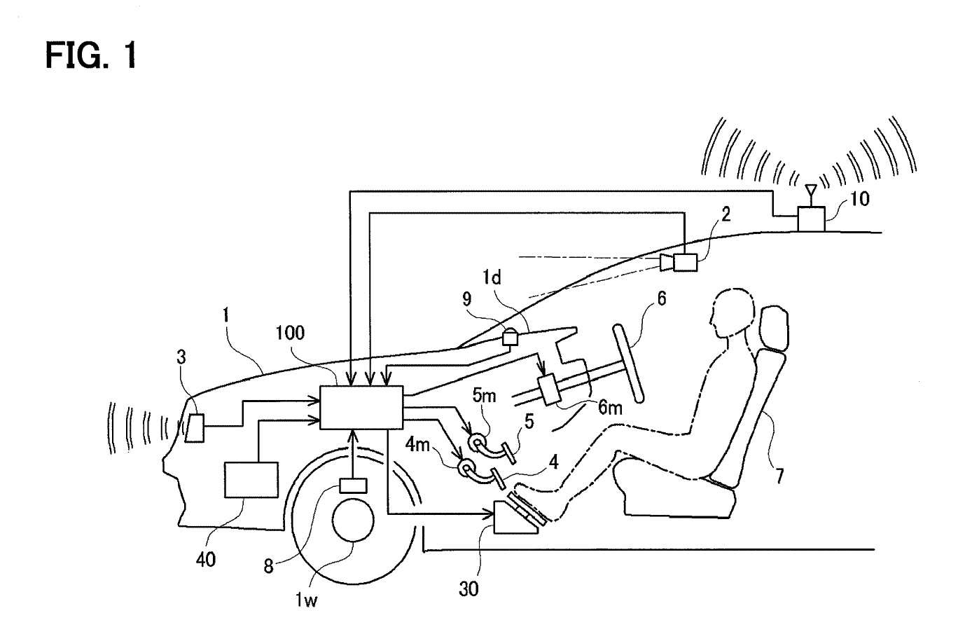

FIG. 1 illustrates a configuration of a subject vehicle 1 on which an autonomous driving control apparatus 100 according to the present embodiment is mounted. The subject vehicle 1 according to the present embodiment includes an in-vehicle camera 2 that captures an image in a traveling direction, a radar 3 that detects a different vehicle or an obstacle present ahead, a vehicle speed sensor 8 that detects a vehicle speed based on revolutions of a wheel 1w, a solar radiation sensor 9 that is mounted on a dashboard 1d of the subject vehicle 1 and that detects detect a quantity of solar radiation, a wireless communicator 10 that wirelessly communicates with the outside, a navigation system 40 (also referred to as navi-system) that indicates a route to a destination set beforehand, an accelerator pedal actuator 4m that drives an accelerator pedal 4, a brake pedal actuator 5m that drives a brake pedal 5, a steering wheel actuator 6m that drives a steering wheel 6, and others.

The navigation system herein generally refers to a system that has a function for detecting a position of the subject vehicle 1, a function for storing map information, a function for setting a destination, a function for searching a route to a destination, and a function for presenting a searched route for route guidance. However, the autonomous driving control apparatus 100 according to the present embodiment is only required to detect a position of the subject vehicle 1 by using the navigation system 40, and recognize a situation ahead of the subject vehicle 1, based on map information stored in the navigation system 40. In this case, the function for searching a route to a set destination and presenting the route is not necessarily needed.

Accordingly, the navigation system 40 according to the present embodiment may be constituted by a general navigation system from which a function for setting a destination, a function for searching a route to a destination, and a function for presenting a searched route are removed.

The autonomous driving control apparatus 100 executes autonomous driving by operating the accelerator pedal actuator 4m, the brake pedal actuator 5m, and the steering wheel actuator 6m in accordance with a route presented by the navigation system 40 while detecting a situation around the subject vehicle 1, based on an image captured by the in-vehicle camera 2 and output from the radar 3. While it is assumed in the description of the present embodiment that the autonomous driving control apparatus 100 detects the surrounding situation only based on the image captured by the in-vehicle camera 2 or on output from the radar 3 to avoid complication of the description, the surrounding situation may be detected by using a not-shown sonar.

A footrest 30 is provided at the foot of a seat 7 which is on a driver seat side and at which the steering wheel 6 is disposed. The footrest 30 receives a foot of an occupant sitting on the seat 7. The footrest 30 according to the present embodiment has a movable portion on which the foot of the occupant is placed. Movement of the footrest 30 is controlled by the autonomous driving control apparatus 100, as will be detailed below.

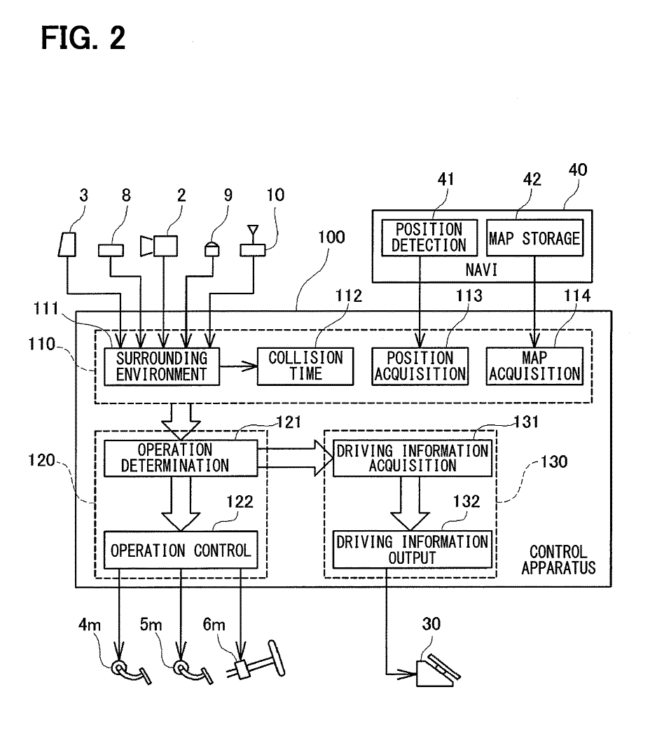

FIG. 2 illustrates a rough internal configuration of the autonomous driving control apparatus 100 according to the present embodiment. As illustrated in FIG. 2, the autonomous driving control apparatus 100 mainly includes three modules configured by a traveling environment acquisition module 110 that acquires various pieces of information relating to a traveling environment of the subject vehicle 1, an autonomous driving execution module 120 that executes autonomous driving, and a driving operation notice module 130 that issues a notice about a detail of an autonomous driving operation to the driver. The autonomous driving execution module 120 corresponds to an autonomous driving controller according to the present disclosure. The driving operation notice module 130 corresponds to driving information output apparatus according to the present disclosure.

The traveling environment acquisition module 110 includes a surrounding environment acquisition part 111, a collision time calculation part 112, a subject vehicle position acquisition part 113, and a map information acquisition part 114. The autonomous driving execution module 120 includes a driving operation determination part 121 and a driving operation control part 122, and the driving operation notice module 130 includes a driving information acquisition part 131 and a driving information output part 132.

Note that these “modules” or “parts” are only abstractions classifying the interior of the autonomous driving control apparatus 100 in view of a function of the autonomous driving control apparatus 100 provided for notifying the driver about a detail of a driving operation during autonomous driving. Accordingly, it is not intended that these expressions physically section the autonomous driving control apparatus 100 into the “modules” or “parts”. Each of the “modules” or “parts” may be realized as a computer program executed by a CPU, as an electronic circuit including LSI and memory, or as a combination of the computer program and electronic circuit.

The surrounding environment acquisition part 111 of the traveling environment acquisition module 110 is connected to the in-vehicle camera 2, the radar 3, the vehicle speed sensor 8, the solar radiation sensor 9, and the wireless communicator 10. In this case, the surrounding environment acquisition part 111 acquires an image captured by the in-vehicle camera 2 and detects a different vehicle, an obstacle, a pedestrian, or the like present ahead of the subject vehicle 1, based on analysis of an image captured by the in-vehicle camera 2. The surrounding environment acquisition part 111 detects the presence or absence of a different vehicle, an obstacle, a pedestrian or the like present ahead, and distances between these objects and the subject vehicle 1 from the radar 3. The surrounding environment acquisition part 111 acquires a speed of the subject vehicle 1 from the vehicle speed sensor 8, and intensity of solar radiation (that is, quantity of solar radiation) from the solar radiation sensor 9. The surrounding environment acquisition part 111 can acquire information about a vehicle speed of a different vehicle, information about indication of a traffic signal, information about a traffic situation, and others through communication with the different vehicle, the traffic signal, a roadside part, or the like present around the subject vehicle 1 by using the wireless communicator 10.

The collision time calculation part 112 calculates a collision time with a different vehicle, an obstacle, a pedestrian, or the like present ahead. The collision time is a prediction time until collision with a different vehicle, an obstacle, a pedestrian or the like present ahead (hereinafter referred to as a front object) on the assumption that a current vehicle speed is continued. The collision time is a time calculated by dividing a distance between the subject vehicle 1 and a front object by a relative speed of the subject vehicle 1 with respect to the front object.

As described above, the surrounding environment acquisition part 111 detects the presence or absence of a front object, and a distance to a front object, based on an image captured by the in-vehicle camera 2 or output from the radar 3. When the surrounding environment acquisition part 111 detects a front object, the collision time calculation part 112 obtains the distance to the detected front object. The collision time calculation part 112 calculates a relative speed of the subject vehicle 1 with respect to the front object, based on the distance to the front object obtained for every elapse of a predetermined time. The collision time calculation part 112 divides the distance to the front object by the relative speed thus obtained to calculate a collision time with the front object.

When the front object is a different vehicle, the relative speed may be calculated based on the difference between a vehicle speed of the different vehicle obtained through vehicle-to-vehicle communication via the wireless communicator 10, and the vehicle speed of the subject vehicle 1 received from the vehicle speed sensor 8.

The subject vehicle position acquisition part 113 acquires a current position of the subject vehicle 1 from a subject vehicle position detection part 41 provided within the navigation system 40. The subject vehicle position detection part 41 detects a current position of the subject vehicle 1, based on a signal received from a navigation satellite.

The map information acquisition part 114 acquires map information about a surrounding area including a current position of the subject vehicle 1 from a map information storage part 42 built in the navigation system 40.

In this case, a distance to a curve or an intersection present ahead of the subject vehicle 1 is predictable based on the current position of the subject vehicle 1 and the map information about the area around the subject vehicle 1. Accordingly, the collision time calculation part 112 may calculate a collision time to the curve or intersection present ahead, based on the information thus acquired.

The driving operation determination part 121 of the autonomous driving execution module 120 acquires the respective types of information described above from the surrounding environment acquisition part 111, the collision time calculation part 112, the vehicle position acquisition part 113, and the map information acquisition part 114 of the traveling environment acquisition module 110, and determines driving operation of the subject vehicle 1, based on the acquired information. The driving operation of the subject vehicle 1 herein refers to a type of driving operation such as acceleration and deceleration, and leftward steering and rightward steering of the subject vehicle 1, and an operation amount of each of the types of the driving operation. An operation amount zero of acceleration or deceleration corresponds to a driving operation maintaining a current speed, while an operation amount zero of leftward steering or rightward steering corresponds to a driving operation for traveling straight ahead.

After the type and operation amount of the driving operation are determined, a subsequent behavior of the subject vehicle 1 (such as vehicle speed, acceleration, transverse acceleration, and transverse speed component) is predictable. Accordingly, any of these behaviors may be included as the driving operation in determination of the driving operation of the subject vehicle 1.

The driving operation control part 122 controls the accelerator pedal actuator 4m, the brake pedal actuator 5m, and the steering wheel actuator 6m in accordance with the driving operation determined by the driving operation determination part 121.

In addition, the driving operation determination part 121 outputs driving information about a detail of the driving operation to the driving information acquisition part 131 of the driving operation notice module 130 prior to output of the determined driving operation to the driving operation control part 122. The driving information acquisition part 131 outputs the received driving information to the driving information output part 132. In this case, the driving information output part 132 operates an actuator built in the footrest 30 to present the driving information to an occupant sitting on the seat 7 on the driver seat side (the occupant being a driver during non-autonomous driving).

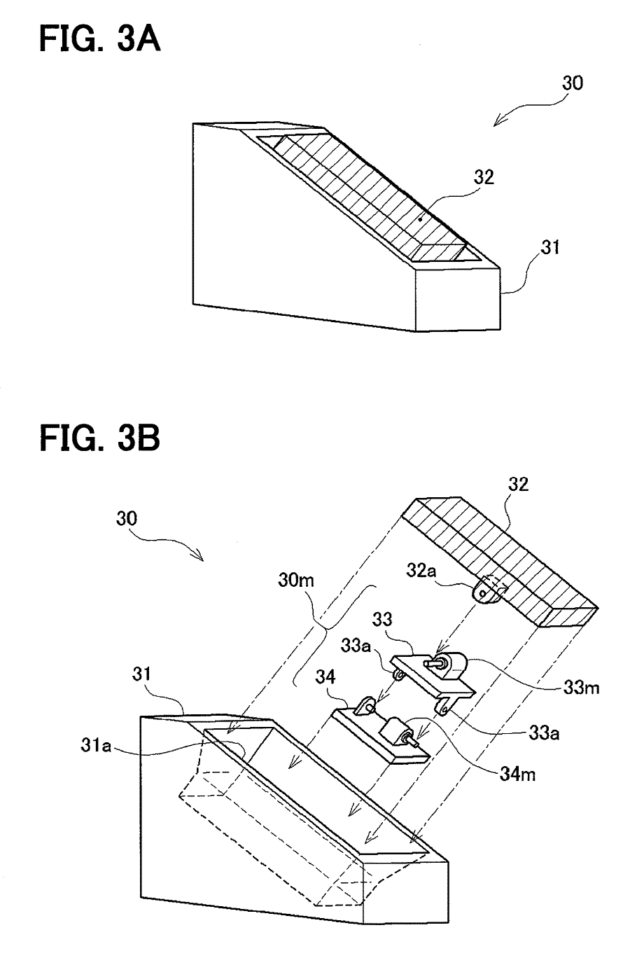

FIGS. 3A and 3B illustrate a rough internal structure of the footrest 30 according to the present embodiment. As illustrated in FIG. 3A, the footrest 30 in the present embodiment includes a main body 31 placed on a floor surface ahead of the seat 7 on the driver seat side, and a footrest portion 32 movable with respect to the main body 31. The occupant sitting on the seat 7 on the driver seat side spontaneously puts a foot of the occupant on the footrest portion 32.

FIG. 3B is an exploded view of the footrest 30 according to the present embodiment. As illustrated in FIG. 3B, a large recess 31a is formed in the main body 31 to store the footrest portion 32 in the recess 31a. The footrest portion 32 is stored in the recess 31a together with a driving mechanism 30m that moves the footrest portion 32.

The driving mechanism 30m of the footrest 30 is configured so as to include a first servo motor 34m attached to a base plate 34 provided on the bottom of the recess 31a, a relay plate 33 attached to an output shaft of the first servo motor 34m, and a second servo motor 33m attached to an upper surface of the relay plate 33. Engagement portions 33a protrude from a bottom surface of the relay plate 33. The engagement portions 33a engage with the output shaft of the first servo motor 34m to fix the relay plate 33 to the output shaft of the first servo motor 34m. In addition, an engagement portion 32a protrudes from a bottom surface of the footrest portion 32. The engagement portion 32a engages with an output shaft of the second servo motor 33m to fix the footrest portion 32 to the output shaft of the second servo motor 33m.

Assembly of the footrest 30 is achieved by attachment of the base plate 34 to the bottom of the recess 31a formed in the main body 31 in the state that the first servo motor 34m, the relay plate 33, the second servo motor 33m, and the footrest portion 32 are attached to the base plate 34.

In this case, the footrest portion 32 is inclined frontward or rearward in the front-rear direction of the subject vehicle 1 in response to driving of the second servo motor 33m. An amount of the frontward inclination or an amount of the rearward inclination is changeable in accordance with a driving amount of the second servo motor 33m. Similarly, the footrest portion 32 is inclined leftward or rightward in the left-right direction of the subject vehicle 1 in response to driving of the first servo motor 34m. An amount of the leftward inclination or an amount of the rightward inclination is changeable in accordance with a driving amount of the first servo motor 34m. The first servo motor 34m and the second servo motor 33m according to the present embodiment correspond to a driving part of the present disclosure.

The autonomous driving control apparatus 100 according to the present embodiment is capable of controlling inclination of the footrest portion 32 by driving the first servo motor 34m and the second servo motor 33m to reduce discomfort given to the occupant sitting on the seat 7 on the driver seat side during autonomous driving of the subject vehicle 1.

### (Autonomous Driving Control Process)

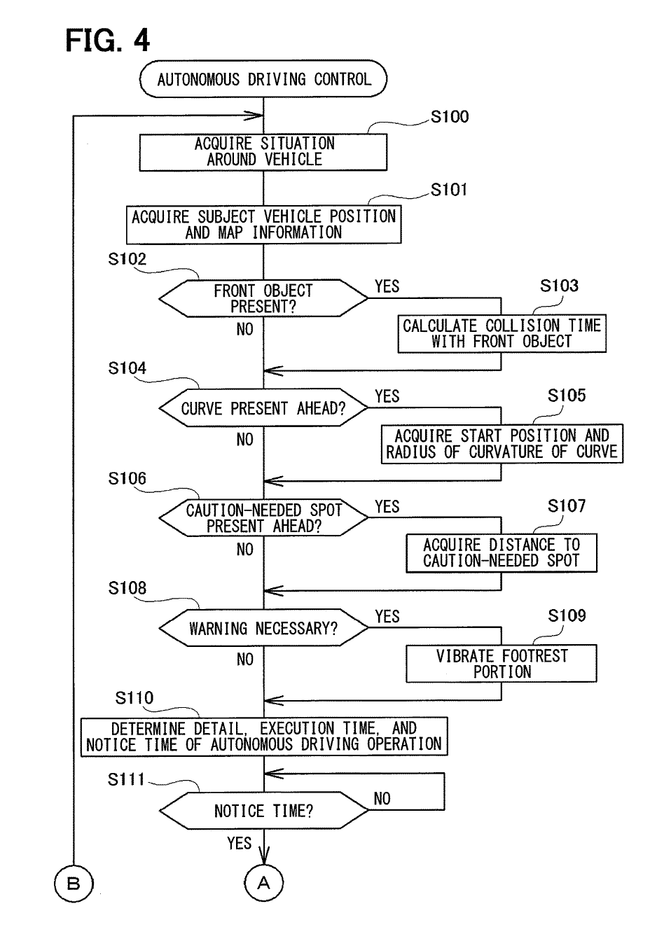

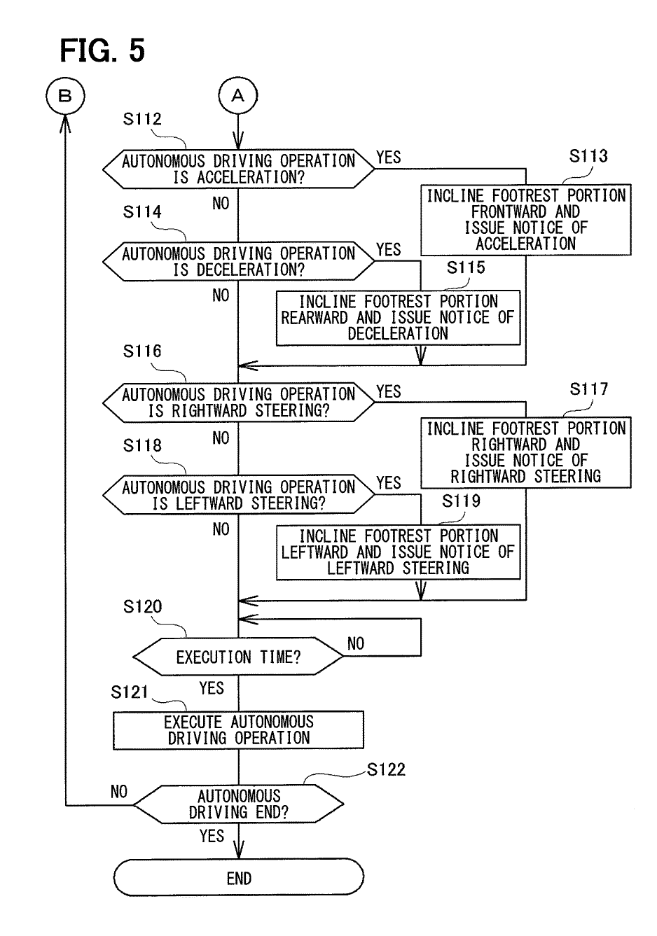

FIGS. 4 and 5 are flowcharts showing an autonomous driving control process executed by the autonomous driving control apparatus 100 according to the present embodiment.

As shown in FIG. 4, a situation around the subject vehicle 1 is initially acquired in the autonomous driving control process (S100). As described with reference to FIG. 2, the autonomous driving control apparatus 100 according to the present embodiment includes the traveling environment acquisition module 110 connected to the in-vehicle camera 2, the radar 3, the vehicle speed sensor 8, the solar radiation sensor 9, and the wireless communicator 10 to acquire a surrounding situation based on output from these equipment. The surrounding situation may be acquired from other equipment such as a sonar mounted on the subject vehicle 1.

Subsequently, a current position of the subject vehicle 1 (hereinafter also referred to as a subject vehicle position), and map information around the subject vehicle 1 including the vehicle position are acquired from the navigation system 40 (S101). As described with reference to FIG. 2, the traveling environment acquisition module 110 is also connected to the navigation system 40 to acquire the subject vehicle position from the subject vehicle position detection part 41 of the navigation system 40, and map information from the map information storage part 42 of the navigation system 40.

Thereafter, it is determined whether a front object (that is, different vehicle, pedestrian, obstacle, or the like present ahead) is present (S102). The presence or absence of a front object is determined based on analysis of an image captured by the in-vehicle camera 2, or analysis of output from the radar 3.

When it is determined that a front object is present (S102: YES), a collision time with the front object is calculated (S103). The collision time is calculated by dividing a distance between the subject vehicle 1 and the front object by a relative speed of the subject vehicle 1 with respect to the front object. The distance between the subject vehicle 1 and the front object is obtained based on output from the radar 3, while the relative speed of the subject vehicle 1 with respect to the front object is obtained based on a change of the distance to the front object with time.

When a front object is absent (S102: NO), it is determined whether a curve is present ahead of the subject vehicle 1 without calculation of a collision time (S104). The presence or absence of a curve may be determined based on a shape of a road included in the acquired map information. Alternatively, a road shape may be acquired based on a lane (or white line) detected from analysis of an image captured by the in-vehicle camera 2.

When it is determined that a curve is present ahead (S104: YES), a start position of the curve and a radius of curvature of the curve are acquired (S105). The start position and the radius of curvature of the curve may be similarly acquired from the map information. Alternatively, the start position and the radius of curvature of the curve may be obtained based on the road shape acquired from the image captured by the in-vehicle camera 2.

When it is determined that a curve is absent ahead of the subject vehicle 1 (S104: NO), it is determined whether a caution-needed spot is present ahead of the subject vehicle 1 without calculation of the start position and radius of curvature of the curve (S106). The caution-needed spot herein refers to a spot which requires caution of the driver during manual driving, such as an intersection, a tunnel entrance or exit, and an end point of an upslope. It is known that a traffic accident easily occurs at an intersection, and thus caution is needed at this spot during driving. Caution is similarly needed during driving at a tunnel entrance or exit where a sharp change of brightness occurs and easily reduces vision. Caution is similarly needed during driving at an end point of an upslope where a switching to a downslope occurs and lowers visibility.

The presence of the caution-needed spot requiring caution of the driver during manual driving is similarly taken into consideration during autonomous driving to reduce discomfort given to the driver by autonomous driving. More specifically, the driver during manual driving tends to decelerate half-automatically (almost on reflex), or drive at a lower speed at the caution-needed spot. Accordingly, the caution-needed spot present ahead of the subject vehicle 1 needs to be similarly recognized during autonomous driving to reduce discomfort given to the driver by autonomous driving.

The caution-needed spot is stored beforehand in the map information acquired from the navigation system 40. Accordingly, the autonomous driving control apparatus 100 is capable of easily determining the presence or absence of the caution-needed spot ahead of the subject vehicle 1 based on the map information. Needless to say, the presence or absence of the caution-needed spot ahead may be determined based on information acquired from the outside via the wireless communicator 10.

Moreover, the driver similarly tends to decelerate half-automatically, or drive at a lower speed when distant visibility is not preferable (that is, low visibility) due to dense fog, heavy snow, heavy rain or like conditions. It is therefore allowed to determine an arrival at a caution-needed spot when a level of visibility detected in the frontward direction of the subject vehicle 1 becomes a predetermined value or lower based on analysis of an image captured by the in-vehicle camera 2.

Alternatively, the presence or absence of a low-visibility spot ahead of the subject vehicle 1, and a distance to a low-visibility spot at the time of the presence of the low-visibility spot may be acquired through communication with the outside via the wireless communicator 10. In this case, the presence of a caution-needed spot may be determined when the low-visibility spot is present within a certain distance from the subject vehicle 1.

When it is determined that a caution-needed spot is present ahead of the subject vehicle 1 (S106: YES), the distance between the subject vehicle 1 and the caution-needed spot is acquired (S107). When a position of the caution-needed spot is also detected, the distance between the subject vehicle 1 and the caution-needed spot is easily obtained based on the position of the subject vehicle 1 already detected.

When it is determined that a caution-needed spot is absent ahead of the subject vehicle 1 (S106: NO), it is determined whether a warning needs to be issued to the occupant of the subject vehicle 1 without acquisition of a distance to a caution-needed spot (S108). The necessity of a warning is determined (S108: YES) when the collision time calculated in S103 is shorter than a predetermined time, or when the distance to the start position of the curve acquired in S107 or the distance to the caution-needed spot acquired in S109 is shorter than a predetermined distance, for example.

When it is determined that a warning needs to be issued (S108: YES), a warning is issued by vibration of the footrest portion 32 of the footrest 30 (S109). According to the present embodiment, the footrest portion 32 is vibrated by driving the first servo motor 34m or the second servo motor 33m. Needless to say, the footrest portion 32 may be vibrated by driving a vibrator mounted on the footrest 30 separately from the first servo motor 34m and the second servo motor 33m.

When it is determined that a warning need not be issued (S108: NO), a detail of autonomous driving operation and an execution time of autonomous driving are determined (S110). When a destination is set for the navigation system 40, for example, whether the accelerator pedal 4, the brake pedal 5, or the steering wheel 6 is operated, and an operation amount is determined based on information on a route presented by the navigation system 40, and the situation around the subject vehicle 1.

Under such a setting as to follow a preceding vehicle, whether the accelerator pedal 4, the brake pedal 5, or the steering wheel 6 is operated, and the operation amount is determined based on detection of the situation around the subject vehicle 1 including the position of the preceding vehicle, based on output from the image captured by the in-vehicle camera 2 or output from the radar 3.

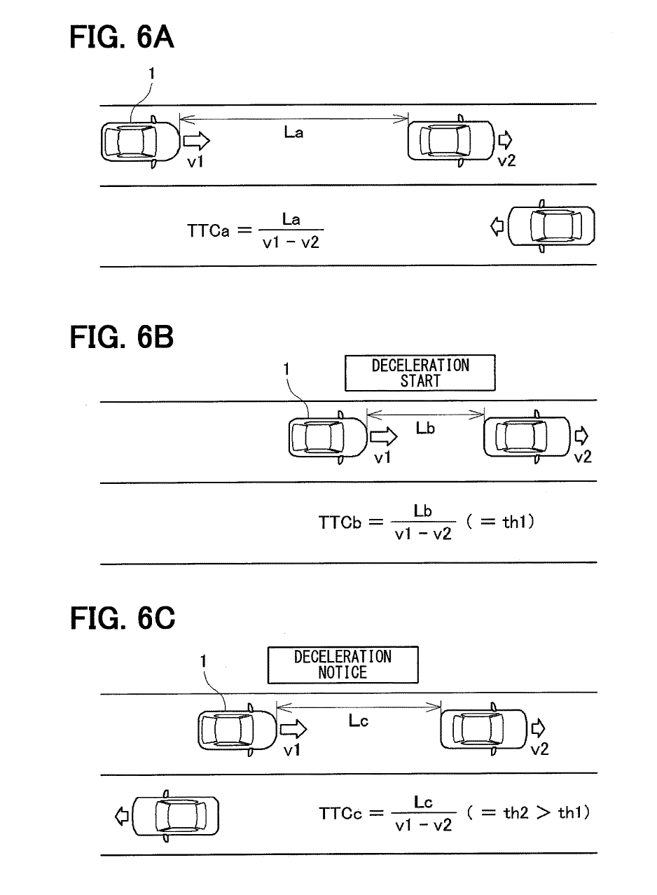

It is assumed herein that a different vehicle traveling at a speed v2 lower than a speed v1 of the subject vehicle 1 is detected during traveling of the subject vehicle 1 at the constant speed v1 as illustrated in FIG. 6A, for example. In this case, a collision time TTCa is calculated by an equation TTCa=La/(v1−v2) when the distance between the subject vehicle 1 and the different vehicle ahead is La.

In this case, a start of deceleration at a deceleration speed corresponding to a relative speed (v1−v2) is determined when a collision time TTCb decreases to a first threshold time th1 (see FIG. 6B). Thereafter, a notice of deceleration is determined when a collision time TTCc decreases to a second threshold time th2 longer than the first threshold time th1 (see FIG. 6C). In S110 of the autonomous control process in FIG. 4, the detail of the autonomous driving operation (deceleration in this example), the execution time of the autonomous driving operation, and further the notice time are determined in this manner.

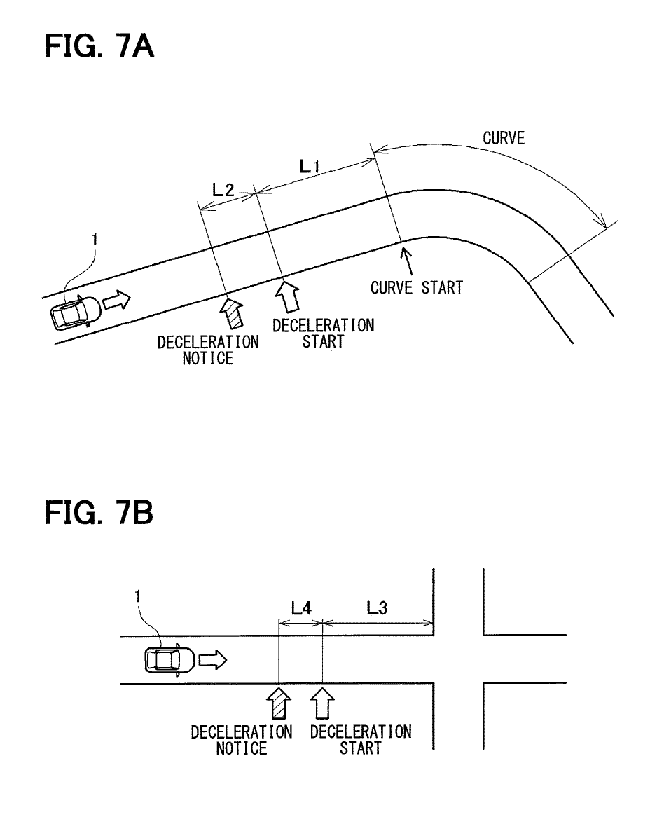

When a curve is present ahead as illustrated in FIG. 7A, the start position of the curve and the radius of curvature of the curve are acquired in S105 in FIG. 4. An appropriate vehicle speed for entering a curve (hereinafter referred to as entrance speed) is determined in accordance with a radius of curvature of the curve. Accordingly, an entrance speed corresponding to the radius of curvature is determined, and compared with the vehicle speed of the subject vehicle 1.

When it is determined that the vehicle speed of the subject vehicle 1 is higher than the entrance speed, initiation of deceleration at a deceleration speed corresponding to the speed difference between the vehicle speed of the subject vehicle 1 and the entrance speed is determined at a point of a distance L1 before the start position of the curve. In addition, a notice of deceleration is determined at a point of a distance L2 further before the point of initiation of deceleration.

When an intersection not equipped with a traffic signal is present ahead as illustrated in FIG. 7B, initiation of a stop with deceleration at a deceleration speed corresponding to the vehicle speed of the subject vehicle 1 is determined at a point of a distance L3 before the position of the intersection to stop at the intersection. In addition, a notice of deceleration is determined at a point of a distance L4 further before the point of initiation of deceleration.

In S110 of the autonomous deriving control process shown in FIG. 4, the detail of the autonomous driving operation, and the execution time and the notice time of the autonomous driving operation are determined in this manner. The detail of the autonomous driving operation thus determined corresponds to driving information according to the present disclosure.

Thereafter, it is determined whether the notice time determined in S110 is arrived (S111). When it is determined that the notice time is not arrived (S111: NO), determination in S111 is repeated to come into a standby state.

When it is determined that the notice time is arrived (S111: YES), it is further determined whether the detail of the determined autonomous driving operation is acceleration (S112 in FIG. 5). When it is determined that the detail of the autonomous driving operation is acceleration (S112: YES), the second servo motor 33m is driven in accordance with the level of the acceleration to incline the footrest portion 32 of the footrest 30 frontward for notice of acceleration (S113). The action for inclining frontward herein refers to an action for producing inclination toward the opposite side as viewed from the occupant sitting on the seat 7 on the driver seat side (driver during non-autonomous driving). Note that the action for inclining frontward and the action for inclining in a frontward direction indicate the same action.

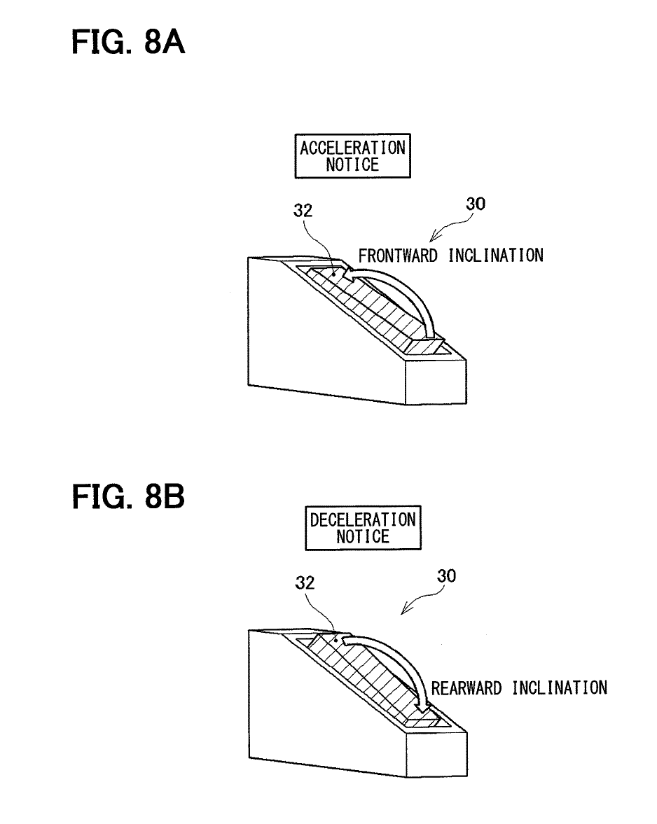

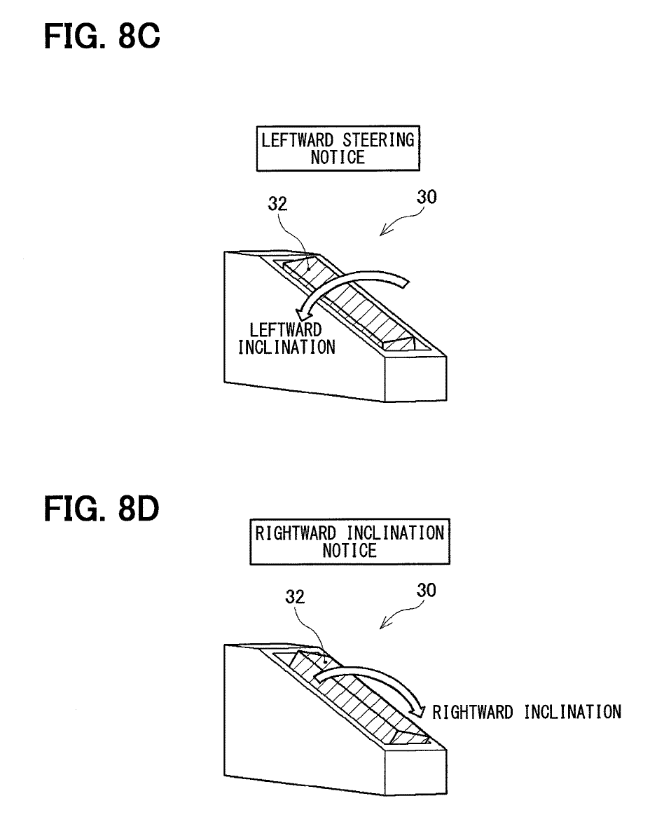

FIG. 8A illustrates an example of frontward inclination of the footrest portion 32 of the footrest 30 for notice of acceleration. A mode for inclining the footrest portion 32 frontward in accordance with a level of acceleration will be described in detail below.

When it is determined that the detail of the autonomous driving operation is not acceleration (S112: NO), it is further determined whether the detail of the autonomous driving operation is deceleration (S114). When it is determined that the detail of the autonomous driving operation is deceleration

(S114: YES), the second servo motor 33m is driven to in accordance with the level of the deceleration to incline the footrest portion 32 of the footrest 30 rearward for notice of deceleration (S115). The action for inclining rearward herein refers to an action for producing inclination toward the near side as viewed from the occupant sitting on the seat 7 on the driver seat side (driver during non-autonomous driving). Note that the action for inclining rearward and the action for inclining in a rearward direction indicate the same action.

FIG. 8B illustrates an example of rearward inclination of the footrest portion 32 of the footrest 30 for notice of deceleration. A mode for inclining the footrest portion 32 rearward inclined in accordance with a level of deceleration will be described in detail below.

When it is determined that the detail of the autonomous driving operation is neither acceleration nor deceleration (S114: NO), the second servo motor 33m is not driven. In this case, a non-inclination state of the footrest portion 32 of the footrest 30 is maintained both frontward and rearward.

Subsequently, it is determined whether the detail of the autonomous driving operation determined in S110 in FIG. 4 is rightward steering by using the steering wheel 6 (hereinafter referred to as rightward steering) (S116). When it is determined that the detail of the autonomous driving operation is rightward steering (S116: YES), the first servo motor 34m is driven in accordance with the amount of steering by the steering wheel 6 to incline the footrest portion 32 of the footrest 30 rightward for notice of rightward steering (S117). The action for inclining rightward herein refers to an action for producing inclination toward the right as viewed from the occupant sitting on the seat 7 on the driver seat side (driver during non-autonomous driving).

FIG. 8D illustrates an example of rightward inclination of the footrest portion 32 of the footrest 30 for notice of rightward steering. A mode for inclining the footrest portion 32 rightward in accordance with a level of rightward steering will be described in detail below.

When it is determined that the detail of the autonomous driving operation is not rightward steering (S116: NO), it is determined whether the detail of the autonomous driving operation is leftward steering by the steering wheel 6 (hereinafter referred to as leftward steering) (S118). When it is determined that the detail of the autonomous driving operation is leftward steering (S118: YES), the first servo motor 34m is driven in accordance with the amount of steering to incline the footrest portion 32 of the footrest 30 leftward for notice of leftward steering (S119). The action for inclining leftward herein refers to an action for producing inclination toward the left as viewed from the occupant sitting on the seat 7 on the driver seat side (driver during non-autonomous driving).

FIG. 8C illustrates an example of leftward inclination of the footrest portion 32 of the footrest 30 for notice of leftward steering. A mode for inclining the footrest portion 32 leftward in accordance with a level of leftward steering will be described in detail below.

When it is determined that the detail of the autonomous driving operation is neither rightward steering nor leftward steering (S118: NO), the first servo motor 34m is not driven. In this case, a non-inclination state of the footrest portion 32 of the footrest 30 is maintained both rightward and leftward.

The occupant does not drive the subject vehicle 1 during autonomous driving. However, the occupant is required to sit on the seat 7 on the driver seat side during autonomous driving so that the occupant can drive instead of the autonomous driving control apparatus 100 at any emergency out of handling by the autonomous driving control apparatus 100. Accordingly, the movement of the footrest portion 32 of the footrest 30 in the manner described above is transmittable to the occupant sitting on the seat 7 on the driver seat side, and recognizable by the occupant as notice of the detail of the autonomous driving operation before execution of the autonomous driving operation.

In this case, the occupant sitting on the seat 7 on the driver seat side recognizes the detail of the autonomous driving operation to be executed beforehand, and feels less uncomfortable during autonomous driving.

Moreover, the occupant is less bothered by burden or noise than the case of a visual or auditory notice, because the detail of the autonomous driving operation is transmitted to the occupant from the movement of the footrest portion 32 of the footrest 30. Accordingly, transmission of the details of the driving operation one by one, when necessary, is smoothly realizable to the occupant without imposing a burden on the occupant during the autonomous driving.

In addition, even when the occupant becomes absent-minded and unalert during autonomous driving, the occupant recognizes the movement of a part of the body (foot placed on the footrest 30 in this example) thus produced with relatively clear consciousness. Furthermore, the occupant intuitively understands the detail of the recognized movement (movement of foot placed on the footrest 30 in this example). Accordingly, even the absent-minded and unalert occupant securely recognizes the detail of the autonomous driving operation.

The movement of the footrest portion 32 of the footrest 30 is determined in the following manners in accordance with the detail of the autonomous driving operation.

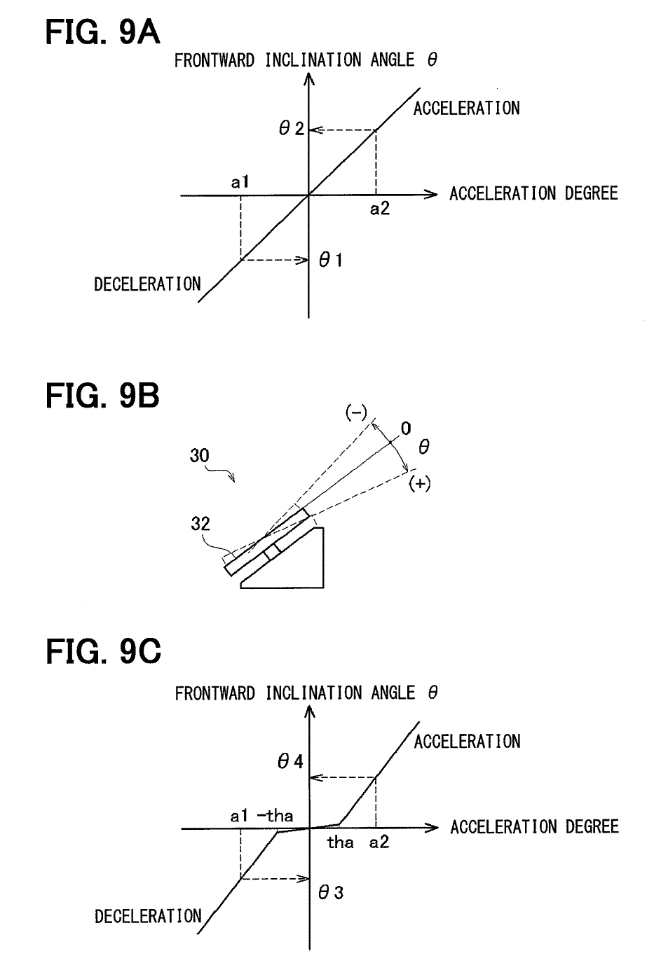

FIGS. 9A to 9C illustrate manners of frontward inclination and rearward inclination of the footrest portion 32 of the footrest 30 in accordance with levels of acceleration and deceleration. As shown in an example in FIG. 9A, a frontward inclination angle θ of the footrest portion 32 is made larger as acceleration increases. Herein, positive acceleration indicates acceleration of the subject vehicle 1, while negative acceleration indicates deceleration of the subject vehicle 1. The frontward inclination angle θ is an angle of inclination of the footrest portion 32 of the footrest 30 as illustrated in FIG. 9B. The frontward inclination angle θ becomes negative during deceleration of the subject vehicle 1. In this case, the footrest portion 32 is inclined rearward.

According to this example, the driver recognizes initiation of acceleration of the subject vehicle 1 based on the frontward inclined movement of the footrest portion 32, or recognizes initiation of deceleration of the subject vehicle 1 based on the rearward inclined movement of the footrest portion 32. Moreover, the driver recognizes the level of acceleration or deceleration based on the degree of the angle of frontward inclination or rearward inclination. After a notice of acceleration or deceleration is issued in this manner, inclination of the footrest portion 32 is returned to the original state to prepare for a next notice of acceleration or deceleration. It is preferable that the speed for returning the footrest portion 32 is a low speed not noticeable by the driver.

As shown in an example of FIG. 9C, a change of the frontward inclination angle θ for a change of acceleration whose absolute value is a predetermined value tha or smaller may be made different from, that is, smaller than, a change of the frontward inclination angle θ for a change of acceleration whose absolute value is a predetermined value tha or larger.

In this case, the driver does not notice, or does not feel disturbed by movement of the footrest portion 32 at a low level of acceleration or deceleration. This example eliminates a possibility of burden given to the driver by movement of the footrest portion 32 produced for each small level of acceleration or deceleration.

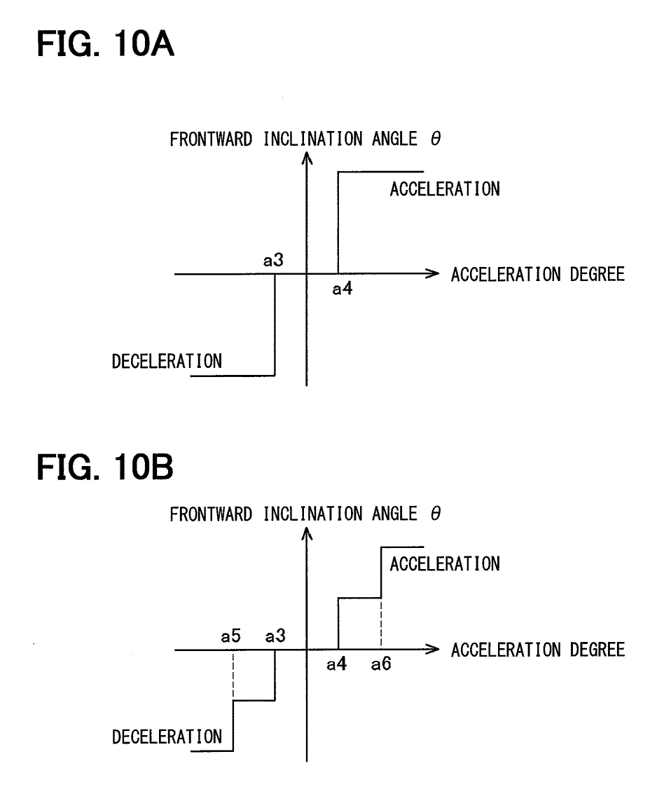

As illustrated in an example of FIG. 10A, the footrest portion 32 may be inclined frontward at a fixed angle of the frontward inclination angle θ at acceleration higher than acceleration a4, and may be maintained without frontward inclination at acceleration lower than the acceleration a4. Similarly, the footrest portion 32 may be inclined rearward at a fixed angle when an absolute value of acceleration in the deceleration direction is larger than a3, and may be maintained without rearward inclination when an absolute value of acceleration in the deceleration direction is smaller than a3.

In this case, the footrest portion 32 does not move at acceleration or deceleration having a lower necessity for notice to the driver. Accordingly, movement of the footrest portion 32 does not become bothersome to the driver. On the other hand, the footrest portion 32 greatly moves at a fixed angle at acceleration or deceleration having a higher necessity for notice to the driver. Accordingly, the driver clearly recognizes initiation of acceleration or deceleration by the subject vehicle 1 based on the movement of the footrest portion 32.

As illustrated in an example of FIG. 10B, the footrest portion 32 may be inclined frontward or rearward at multiple stages. At the time of acceleration of the subject vehicle 1, the footrest portion 32 is inclined frontward at a certain angle when acceleration is higher than a4. However, the footrest portion 32 may be inclined frontward at a still larger angle when acceleration is higher than a6 that is higher than a4.

In this case, the driver recognizes an approximate level of acceleration based on approximate movement of the footrest portion 32. Accordingly, the driver is allowed to appropriately and sufficiently recognize the detail of the autonomous driving in need.

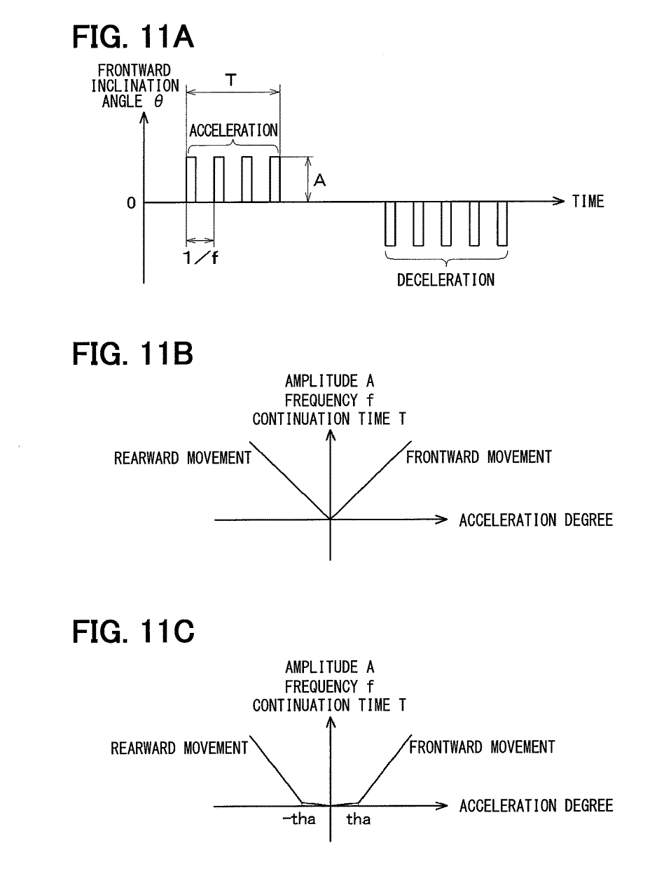

A level of acceleration or deceleration may be transmitted to the driver by frontward and rearward oscillation of the inclination of the footrest portion 32 of the footrest 30. For example, the footrest portion 32 is vibrated toward the opposite side of the seat on the driver seat side at the time of acceleration of the subject vehicle 1, or vibrated toward the near side of the seat on the driver seat side at the time of deceleration of the subject vehicle 1 as illustrated in FIG. 11A. In this case, the driver recognizes initiation of acceleration or deceleration of the subject vehicle 1 based on the direction of vibration of the footrest portion 32.

An amplitude A of vibration of the footrest portion 32, a frequency f of the vibration, and a continuation time T of the vibration may be varied in accordance with the level of acceleration or the level of deceleration. For example, the footrest portion 32 may be vibrated in such a manner that at least one of the amplitude A, the frequency f, and the continuation time T increases as the absolute value of acceleration or deceleration becomes larger as illustrated in FIG. 11B. In this case, the driver also recognizes the level of acceleration or deceleration based on the manner of vibration of the footrest portion 32.

A change amount of the amplitude A, a change amount of the frequency f, or a change amount of the continuation time T of a change of acceleration or deceleration per unit amount in a range of absolute values smaller than the threshold tha may be made different from the corresponding change amount in a range of absolute values larger than the threshold tha. More specifically, as illustrated in an example of FIG. 11C, a change amount of the amplitude A, a frequency f, and a continuation time T for a change of acceleration or deceleration per unit amount in the range of absolute values of acceleration or deceleration smaller than the threshold tha may be made smaller than the corresponding change amount in the range of absolute values larger than the threshold tha. In this case, the driver does not notice vibration of the footrest portion 32, or does not feel disturbed by this vibration at the time of low acceleration or deceleration. This example eliminates a possibility that vibration of the footrest portion 32 becomes bothersome to the driver for every low acceleration or deceleration.

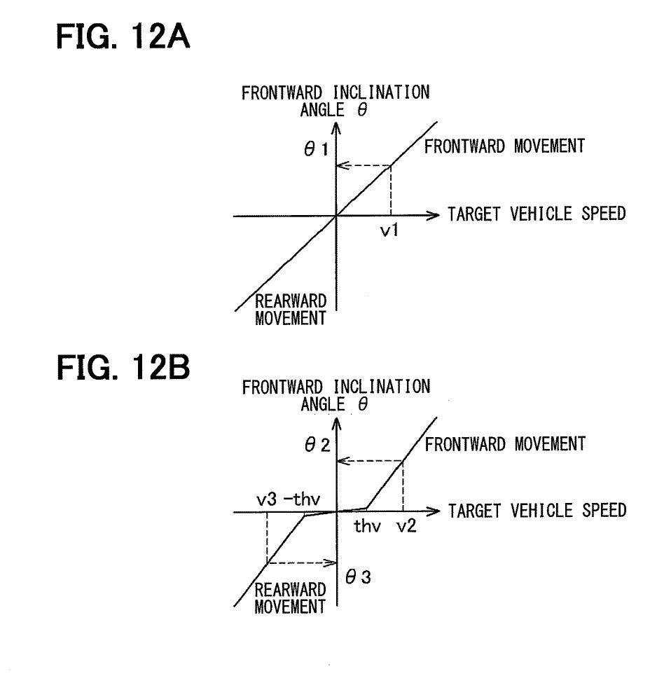

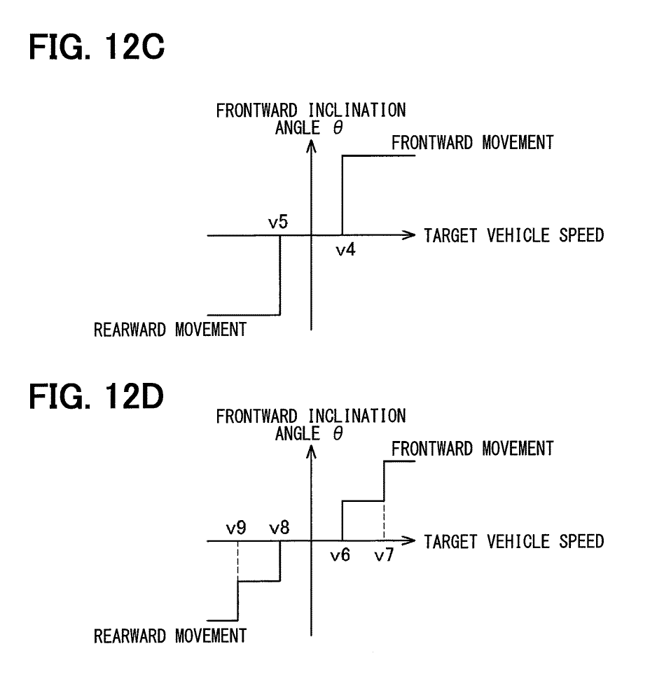

As illustrated in examples in FIGS. 12A to 12D, the footrest portion 32 may be inclined frontward such that the inclination angle becomes a frontward inclination angle θ corresponding to a control target value of the vehicle speed of the subject vehicle 1 (that is, target vehicle speed). In this case, the driver recognizes a target vehicle speed based on the frontward inclination angle θ of the footrest portion 32.

When the frontward inclination angle θ changes with the target vehicle speed, a change amount of the frontward inclination angle θ for a change amount of the target vehicle speed in a range of absolute values of the target vehicle speed smaller than a threshold vehicle speed thy may be made smaller than the corresponding change amount in a range of absolute values of the target vehicle speed larger than the threshold thy as illustrated in FIG. 12B. Alternatively, as illustrated in FIGS. 12C and 12D, a change of the frontward inclination angle θ may be varied in stages with a change of the target vehicle speed.

When the target vehicle speed changes, the driver may recognize the change of the target vehicle speed based on oscillations of the frontward inclination angle θ of the footrest portion 32. In this case, the footrest portion 32 is vibrated in the direction from the seat on the driver seat side toward the opposite side to the seat with a rise of the target vehicle speed, or vibrated in the direction from the seat on the driver seat side toward the near side to the seat with a drop of the target vehicle speed. According to this example, the driver recognizes the rise of the target vehicle speed or the drop of the target vehicle speed based on the direction of vibration of the footrest portion 32.

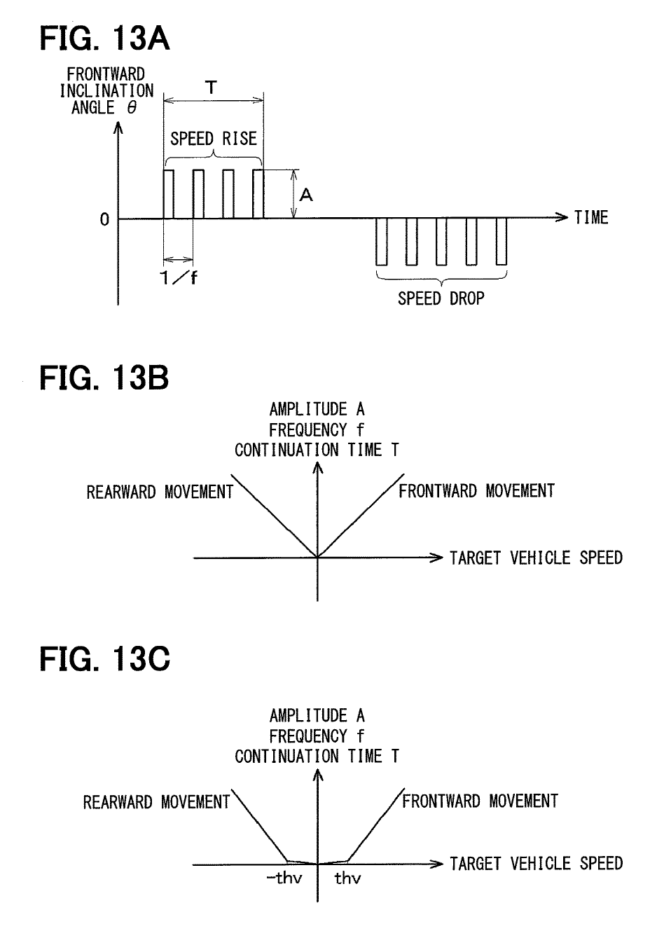

The amplitude A of the vibration of the footrest portion 32, the frequency f of the vibration, and the continuation time T of the vibration may be varied in accordance with the target vehicle speed. For example, the footrest portion 32 may be vibrated in such a manner that at least one of the amplitude A, the frequency f, and the continuation time T increases as an absolute value of the target vehicle speed becomes larger as illustrated in FIGS. 13B and 13C. In this case, a change amount of the amplitude A, a change amount of the frequency f, or a change amount of the continuation time T for a change of the target vehicle speed per unit amount may be varied depending on whether an absolute value of the target vehicle speed is smaller than the predetermined threshold speed thv.

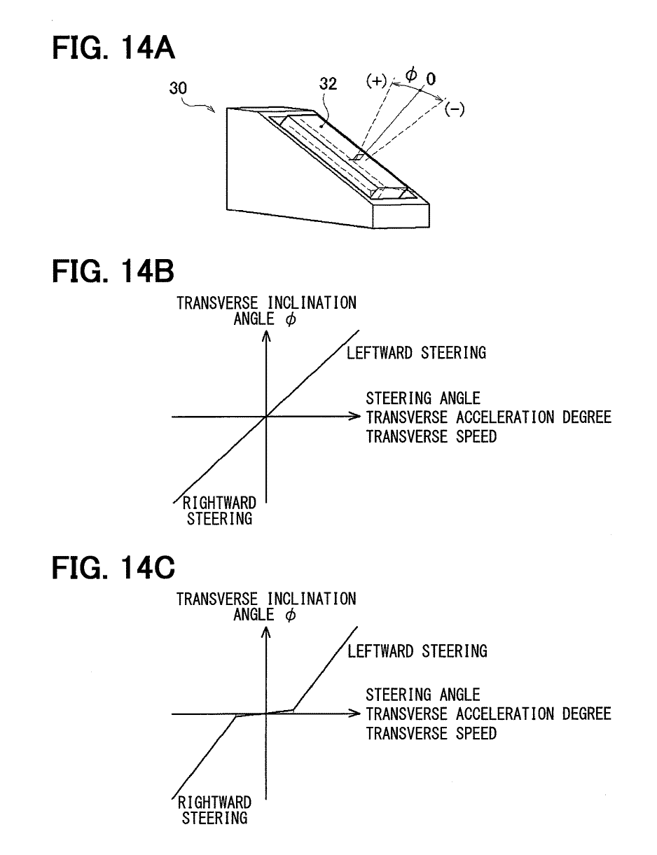

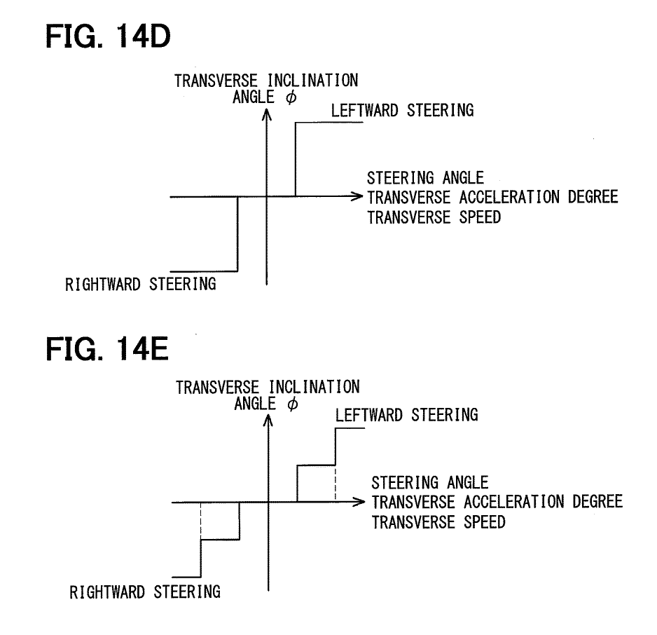

FIGS. 14A to 14E illustrate examples of leftward and rightward inclination of the footrest portion 32 of the footrest 30 in accordance with a steering angle of left steering or right steering. Steering during traveling generates acceleration or an acceleration component in a direction transverse to the traveling direction. The levels of the acceleration and the acceleration component increase, as the steering angle becomes larger. Accordingly, the footrest portion 32 may be inclined leftward and rightward in accordance with acceleration in the transverse direction (hereinafter referred to as transverse acceleration) generated by steering, or the speed component in the transverse direction (hereinafter referred to as transverse speed).

The steering angle, and the transverse acceleration and the transverse speed generated by steering are hereinafter also collectively referred to as steering information. The angle of leftward or rightward inclination of the footrest portion 32 is referred to as a transverse inclination angle φ. It is assumed that the transverse inclination angle φ becomes a positive value when the footrest portion 32 is inclined leftward as illustrated in FIG. 14A.

As illustrated in an example of FIG. 14B, the transverse inclination angle φ of leftward inclination of the footrest portion 32 increases as the steering information in the direction of leftward steering increases. Positive acceleration indicates leftward steering of the subject vehicle 1, while negative acceleration indicates rightward steering of the subject vehicle 1. As illustrated in FIG. 14A, the transverse inclination angle φ is an angle for leftward inclination of the footrest portion 32 of the footrest 30. At the time of rightward steering of the subject vehicle 1, the transverse inclination angle φ becomes a negative value, and thus the footrest portion 32 is inclined rightward.

In this case, the driver recognizes initiation of leftward steering of the subject vehicle 1 based on leftward inclination of the footrest portion 32, or recognizes initiation of rightward steering of the subject vehicle 1 based on rightward inclination of the footrest portion 32. Furthermore, the driver recognizes the level of the steering information based on the degree of the leftward inclination angle or the rightward inclination angle. After the issue of the notice of the leftward steering or the rightward steering in this manner, inclination of the footrest portion 32 is returned to the original state to prepare for a next notice of steering. It is preferable that the speed for returning the footrest portion 32 is a low speed not noticeable by the driver.

As illustrated in an example of FIG. 14C, the degree of the transverse inclination angle φ for the steering information at a level of a predetermined value or lower of the steering information may be different from, that is, made smaller than, the corresponding degree at a level of the predetermined value or higher of the steering information. In this case, the driver does not notice (or does not feel disturbed by) movement of the footrest portion 32 at the time of small-scale steering. This example therefore eliminates a possibility that movement of the footrest portion 32 becomes bothersome to the driver.

As illustrated in examples of FIGS. 14D and 14E, the degree of the transverse inclination angle φ may be varied in stages for a change of the steering information. In this case, the footrest portion 32 does not move at small-scale steering having a smaller necessity of notice to the driver. Accordingly, movement of the footrest portion 32 does not become bothersome to the driver.

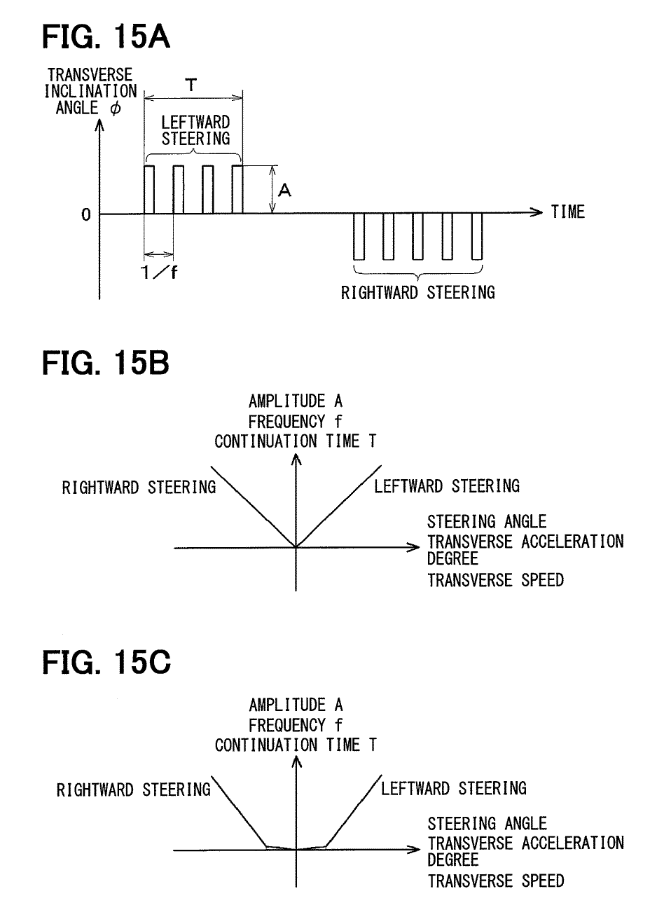

The transverse inclination angle φ of the footrest portion 32 may be oscillated in accordance with the steering information to notify the driver about initiation of steering of the subject vehicle 1. More specifically, the footrest portion 32 is vibrated leftward at the time of initiation of leftward steering of the subject vehicle 1, or vibrated rightward at the time of initiation of rightward steering of the subject vehicle 1 as illustrated in FIG. 15A. In this case, the driver recognizes leftward steering or rightward steering based on the direction of vibration of the footrest portion 32.

The amplitude A of the vibration of the footrest portion 32, the frequency f of the vibration, and the continuation time T of the vibration may be varied in accordance with a level of the steering information. For example, the footrest portion 32 may be vibrated in such a manner that at least one of the amplitude A, the frequency f, and the continuation time T increases as the level of the steering information becomes larger as illustrated in examples of FIGS. 15B and 15C. In this case, a change amount of the amplitude A, a change amount of the frequency f, or a change amount of the continuation time T for a change of the level of the steering information per unit amount may be varied depending on whether an absolute value of the steering information is smaller than a predetermined threshold.

In S113, S115, S117, and S119 in FIG. 5, the footrest portion 32 of the footrest 30 is inclined frontward, rearward, leftward, or rightward in the manner described above to notify the driver about the detail of the autonomous driving determined in S110 in FIG. 4.

Thereafter, the autonomous driving control apparatus 100 drives the accelerator pedal actuator 4m, the brake pedal actuator 5m, and the steering wheel actuator 6m in correspondence with the detail determined in S110 to execute an autonomous driving operation (S121).

Subsequently, it is determined whether to end the autonomous driving performed by the autonomous driving control apparatus 100 (S122). When the autonomous driving is not to end (S122: NO), the process returns to the initial step to obtain the surrounding situation of the subject vehicle 1 (S100 in FIG. 4), and execute the series of processing (S101 to S122) after the initial step. When it is determined that the autonomous driving is to end after a repeat of operations in this manner (S122: YES), the autonomous driving control process shown in FIGS. 4 and 5 ends.

### (Modified Examples)

According to the description of the above-described embodiment, the occupant sitting on the seat 7 on the driver seat side recognizes the detail of the autonomous driving operation, based on frontward or rearward, or leftward or rightward inclination of the footrest portion 32 of the footrest 30. However, movement of the footrest portion 32 is not limited to inclination movement, but may be a translational shift of the footrest portion 32, for example.

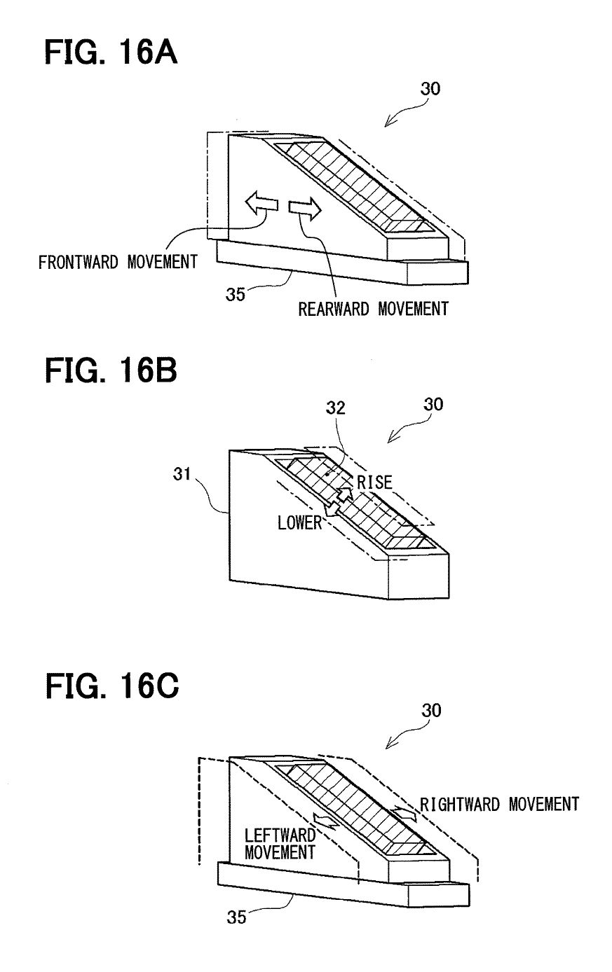

FIGS. 16A to 16C illustrate examples of a translational shift of the footrest portion 32 of the footrest 30 in accordance with the detail of the autonomous driving operation.

For example, the footrest 30 shown in FIG. 16A is configured to shift in the front-rear direction on a base 35 to allow a translational shift of the footrest portion 32 together with the footrest 30 in accordance with driving of an actuator (not shown).

In this case, the occupant similarly recognizes initiation of acceleration of the subject vehicle 1 based on frontward movement of the footrest 30 (corresponding to S113 in FIG. 5) when the detail of the autonomous driving operation is acceleration (corresponding to S112: YES), or initiation of deceleration based on rearward movement of the footrest 30 (corresponding to S115) when the detail of the autonomous driving operation is deceleration (corresponding to S114: YES).

Alternatively, the footrest portion 32 may be configured to rise and lower from the main body 31 in accordance with driving of an actuator (not shown) as illustrated in FIG. 16B.

In this case, the occupant similarly recognizes initiation of acceleration of the subject vehicle 1 based on lowering movement of the footrest 30 (corresponding to S113 in FIG. 5) when the detail of the autonomous driving operation is acceleration (corresponding to S112: YES), or initiation of deceleration of the subject vehicle 1 based on rising movement of the footrest 30 (corresponding to S115) when the detail of the autonomous driving operation is deceleration (corresponding to S114: YES).

In addition, the occupant recognizes initiation of leftward or rightward steering of the subject vehicle 1 from a translational shift of the footrest portion 32.

For example, the footrest 30 in FIG. 16C is configured to shift in the left-right direction on the base 35 to allow a translational shift of the footrest portion 32 together with the footrest 30 in accordance with driving of the actuator (not shown).

In this case, the occupant similarly recognizes initiation of rightward steering of the subject vehicle 1 based on a rightward shift of the footrest 30 (rightward movement) (corresponding to S117 in FIG. 5) when the detail of the autonomous driving operation is rightward steering (corresponding to S116: YES), or initiation of leftward steering of the subject vehicle 1 based on a leftward shift of the footrest 30 (leftward movement) (corresponding to S119) when the detail of the autonomous driving operation is leftward steering (corresponding to S118: YES).

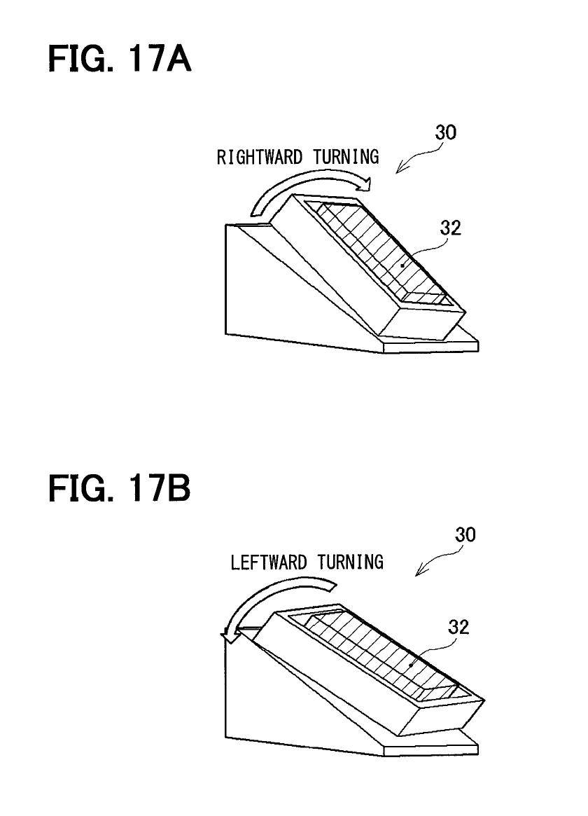

As illustrated in examples of FIGS. 17A and 17B, the occupant may recognize rightward steering or leftward steering of the subject vehicle 1 based on a swing in a right direction (hereinafter referred to as rightward swing or rightward turning) of the footrest portion 32, or a swing in a left direction (hereinafter referred to as leftward swing or leftward turning) of the footrest portion 32.

In this case, the occupant similarly recognizes initiation of rightward steering of the subject vehicle 1 based on a rightward swing of the footrest portion 32 (corresponding to S117 in FIG. 5) when the detail of the autonomous driving operation is rightward steering (corresponding to S116: YES), or initiation of leftward steering of the subject vehicle 1 based on a leftward swing of the footrest portion 32 (corresponding to S119) when the detail of the autonomous driving operation is leftward steering (corresponding to S118: YES).

According to the embodiment or modified examples described above, the footrest portion 32 of the footrest 30 is shifted. It is generally assumable that the occupant sitting on the seat 7 on the driver seat side places the foot of the occupant on the footrest 30 even during autonomous driving. Accordingly, the occupant sitting on the seat 7 on the driver seat side recognizes the detail of the autonomous driving operation based on a shift of the footrest portion 32 of the footrest 30. However, a part to be shifted in accordance with the detail of the autonomous driving operation may be one of parts other than the footrest portion 32 of the footrest 30 as long as the occupant sitting on the seat 7 on the driver seat side securely notices movement of the shifted part during autonomous driving. For example, various types of adjustment mechanisms are mounted on the seat 7 on the driver seat side. In this case, at least a part of the seat 7 on the driver seat side may be shifted by using the adjustment mechanisms to notify the occupant sitting on the seat 7 on the driver seat side about the detail of the autonomous driving operation.

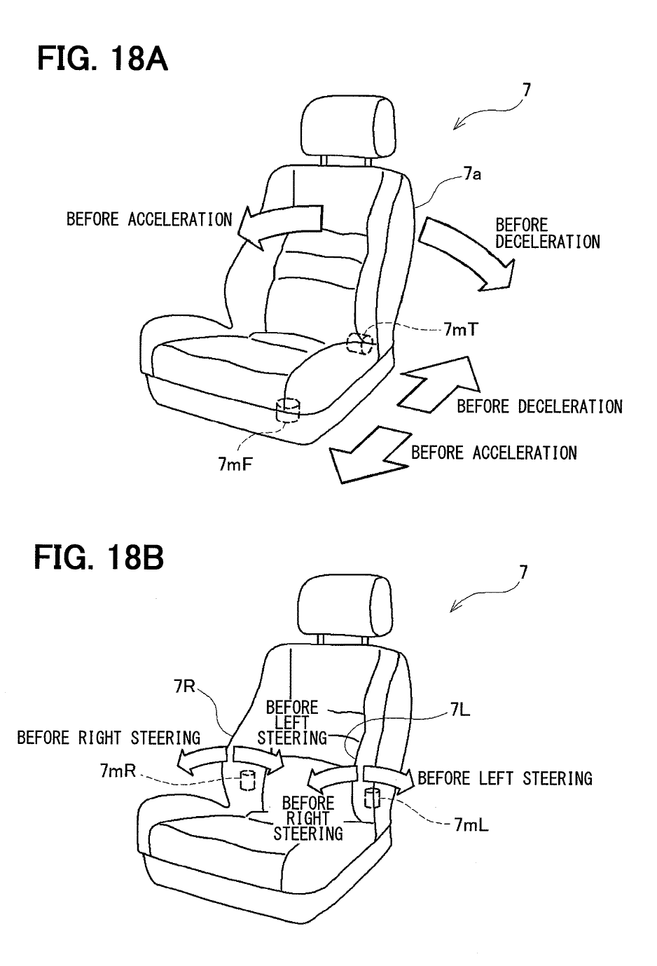

FIGS. 18A and 18B illustrate examples of a movement of at least a part of the seat 7 on the driver seat side in accordance with the detail of the autonomous driving operation.

FIG. 18A shows an example of the seat 7 equipped with an electric actuator 7mF that slides a seat position in the front-rear direction. In this case, the seat 7 is shifted frontward before acceleration, and is shifted rearward before deceleration. Alternatively, in case of the seat 7 equipped with an electric actuator 7mT that changes inclination of a backrest portion 7a of the seat 7, the backrest portion 7a of the seat 7 is returned before acceleration, and is reclined before deceleration.

According to this example, the occupant sitting on the seat 7 recognizes initiation of acceleration or deceleration of the subject vehicle 1 based on a shift of the seat 7 or the backrest portion 7a. Note that each of the electric actuator 7mF and the electric actuator 7mT corresponds to an adjustment part according to the present disclosure.

When lumber support portions 7R and 7L of the seat 7 are configured to be inclined leftward and rightward by electric actuators 7mR and 7mL built in the lumber support portions 7R and 7L, respectively, the occupant recognizes initiation of rightward steering or leftward steering of the subject vehicle 1 based on the inclinations of the lumber support portions 7R and 7L as illustrated in FIG. 18B. More specifically, at the time of initiation of rightward steering of the subject vehicle 1, the lumber support portions 7R and 7L are inclined rightward. On the other hand, at the time of initiation of leftward steering of the subject vehicle 1, the lumber support portions 7R and 7L are inclined leftward.

In this case, the occupant sitting on the seat 7 recognizes initiation of leftward steering or rightward steering of the subject vehicle 1 based on a shift of the lumber support portions 7R and 7L of the seat 7. Note that each of the electric actuator 7mL and the electric actuator 7mR corresponds to the adjustment part in the present disclosure.

When a situation difficult to handle by the autonomous driving control apparatus 100 during autonomous driving occurs, the driver is required to perform driving in place of the autonomous driving control apparatus 100. In this case, the footrest portion 32 of the footrest 30 may be vibrated to issue a request of override (driving operation interference by driver during autonomous driving to switch from autonomous driving state to manual driving state) to the driver.

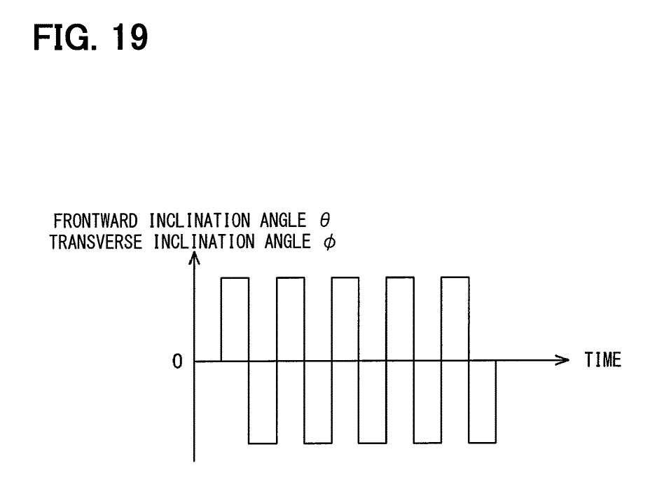

For example, frontward inclination and rearward inclination of the footrest portion 32 are repeated in a fixed cycle, or leftward inclination and rightward inclination of the footrest portion 32 are repeated in a fixed cycle as shown in FIG. 19. This movement is obviously different from an ordinary notice of details of autonomous driving, and therefore the driver easily recognizes a request of override.

The description has been made based on the embodiment and the modified examples. However, the present disclosure is not limited to the embodiment and modified examples described, but may be practiced in various other modes without departing from the scope of the subject matters of the present disclosure.

It is noted that a flowchart or the processing of the flowchart in the present application includes multiple steps (also referred to as sections), each of which is represented, for instance, as S100. Further, each step can be divided into several sub-steps while several steps can be combined into a single step.

While various embodiments, configurations, and aspects of autonomous driving control apparatus, driving information output apparatus, footrest, autonomous driving control method, and driving information output method have been exemplified, the embodiments, configurations, and aspects of the present disclosure are not limited to those described above. For example, embodiments, configurations, and aspects obtained from an appropriate combination of technical elements disclosed in different embodiments, configurations, and aspects are also included within the scope of the embodiments, configurations, and aspects of the present disclosure.

What is claimed is:

1-36. (canceled)

37. An autonomous driving control apparatus that achieves autonomous driving by controlling a driving operation of a subject vehicle, based on a situation around the subject vehicle, the autonomous driving control apparatus comprising:
a driving operation determination part that determines a detail of the driving operation of the subject vehicle, based on the situation around the subject vehicle;
a driving operation control part that controls the driving operation of the subject vehicle in accordance with the detail determined of the driving operation; and
a driving information output part that shifts a footrest portion of a footrest at a seat on a driver seat side of the subject vehicle by driving a driving part provided on the footrest, to output the detail determined of the driving operation as driving information,
wherein:
the driving information output part varies a frontward inclination angle, being an inclination angle of the footrest portion in a front-rear direction, in accordance with a level of acceleration or deceleration of the subject vehicle, to output the driving information.

38. The autonomous driving control apparatus according to claim 37, wherein:
the driving information output part varies the frontward inclination angle such that a change amount of the frontward inclination angle for the level of the acceleration or the deceleration of the subject vehicle is smaller in a range of the level of the acceleration or the deceleration lower than a predetermined value, than in a range of the level of the acceleration or the deceleration higher than the predetermined value.

39. The autonomous driving control apparatus according to claim 37, wherein:
the driving information output part varies the frontward inclination angle, in accordance with a relationship between the level of the acceleration or the deceleration of the subject vehicle and a predetermined threshold, to output the driving information.

40. The autonomous driving control apparatus according to claim 39, wherein:
the driving information output part varies the frontward inclination angle in accordance with relationships between the level of the acceleration or the deceleration of the subject vehicle and a plurality of thresholds, to output the driving information.

41. The autonomous driving control apparatus according to claim 37, wherein:
the driving information output part oscillates the frontward inclination angle in a manner corresponding to the level of the acceleration or the deceleration of the subject vehicle, to output the driving information.

42. An autonomous driving control apparatus that achieves autonomous driving by controlling a driving operation of a subject vehicle, based on a situation around the subject vehicle, the autonomous driving control apparatus comprising:
a driving operation determination part that determines a detail of the driving operation of the subject vehicle, based on the situation around the subject vehicle;
a driving operation control part that controls the driving operation of the subject vehicle in accordance with the detail determined of the driving operation; and
a driving information output part that shifts a footrest portion of a footrest at a seat on a driver seat side of the subject vehicle by driving a driving part provided on the footrest, to output the detail determined of the driving operation as driving information,
wherein:
the driving information output part varies a frontward inclination angle, being an inclination angle of the footrest portion in a front-rear direction, in accordance with a vehicle speed of the subject vehicle, to output the driving information.

43. The autonomous driving control apparatus according to claim 42, wherein:
the driving information output part varies the frontward inclination angle such that a change amount of the frontward inclination angle for the vehicle speed of the subject vehicle is smaller in a range of the vehicle speed lower than a predetermined value, than in a range of the vehicle speed higher than the predetermined value.

44. The autonomous driving control apparatus according to claim 42, wherein:
the driving information output part varies the frontward inclination angle in accordance with a relationship between the vehicle speed of the subject vehicle and a predetermined threshold, to output the driving information.

45. The autonomous driving control apparatus according to claim 44, wherein:
the driving information output part varies the frontward inclination angle in accordance with relationships between the vehicle speed of the subject vehicle and a plurality of thresholds, to output the driving information.

46. The autonomous driving control apparatus according to claim 42, wherein:
the driving information output part oscillates the frontward inclination angle in a manner corresponding to the vehicle speed of the subject vehicle, to output the driving information.

47. An autonomous driving control apparatus that achieves autonomous driving by controlling a driving operation of a subject vehicle, based on a situation around the subject vehicle, the autonomous driving control apparatus comprising:
a driving operation determination part that determines a detail of the driving operation of the subject vehicle, based on the situation around the subject vehicle;
a driving operation control part that controls the driving operation of the subject vehicle in accordance with the detail determined of the driving operation; and
a driving information output part that shifts a footrest portion of a footrest at a seat on a driver seat side of the subject vehicle by driving a driving part provided on the footrest, to output steering information about steering of the subject vehicle as driving information representing the detail determined of the driving operation,
wherein:
the driving information output part outputs the steering information that is either a steering angle of the subject vehicle, or acceleration in a transverse direction with respect to a traveling direction of the subject vehicle or a speed component in the transverse direction.

48. The autonomous driving control apparatus according to claim 47, wherein:
the driving information output part varies a transverse inclination angle, being an inclination angle of the footrest portion in a left-right direction, in accordance with a level of the steering information of the subject vehicle, to output the driving information.

49. The autonomous driving control apparatus according to claim 48, wherein:
the driving information output part varies a frontward inclination angle such that a change amount of the transverse inclination angle for the level of the steering information is smaller in a range of the steering information lower than a predetermined value, than in a range of the steering information higher than the predetermined value.

50. The autonomous driving control device according to claim 47, wherein:
the driving information output part varies a transverse inclination angle, being an inclination angle of the footrest portion in a left-right direction, in accordance with a relationship between a level of the steering information and a predetermined threshold, to output the driving information.

51. The autonomous driving control apparatus according to claim 50, wherein:
the driving information output part varies the transverse inclination angle in accordance with relationships between the level of the steering information and a plurality of threshold angles, to output the driving information.

52. The autonomous driving control apparatus according to claim 47, wherein:
the driving information output part oscillates frontward and rearward inclination of the footrest portion in a manner corresponding to a level of the steering information, to output the driving information.

53. The autonomous driving control apparatus according to claim 37, wherein:
the driving operation determination part determines the detail of the driving operation, and an execution time of the driving operation;
the driving operation control part controls the driving operation of the subject vehicle in accordance with the detail determined of the driving operation and the execution time determined; and
the driving information output part outputs the driving information at a time earlier than the execution time determined.

54. The autonomous driving control apparatus according to claim 53, further comprising:
a collision time calculation part that obtains a distance to a front object being a different vehicle or an obstacle present ahead, and a relative speed of the subject vehicle with respect to the front object, and calculates a collision time with respect to the front object,
wherein:
the driving operation determination part determines the execution time of the driving operation, based on comparison between a predetermined first threshold time and the collision time; and
the driving information output part outputs the driving information at a time determined based on comparison between the collision time and a predetermined second threshold time that is longer than the first threshold time.

55. The autonomous driving control apparatus according to claim 53, further comprising:
a subject vehicle position acquisition part that acquires a subject vehicle position where the subject vehicle is present; and
a map information acquisition part that acquires map information indicating an area including the subject vehicle position,
wherein:
the driving operation determination part determines the detail of the driving operation based on the subject vehicle position and the map information, and further determines the execution time of the driving operation, based on determination of the subject vehicle position where the driving operation is performed on the map information; and
the driving information output part outputs the driving information at a position ahead of the subject vehicle position where the driving operation is performed on the map information by a predetermined distance from the subject vehicle position.

56. The autonomous driving control apparatus according to claim 53, further comprising:
a surrounding environment acquisition part that acquires a surrounding environment of the subject vehicle,
wherein:
the driving operation determination part determines the detail of the driving operation and the execution time of the driving operation, based on the surrounding environment.

57. The autonomous driving control apparatus according to claim 56, wherein:
the surrounding environment acquisition part acquires the surrounding environment that is a road shape ahead of the subject vehicle by analyzing an image captured by an in-vehicle camera mounted on the subject vehicle; and
the driving operation determination part determines the detail and the execution time of the driving operation, based on the road shape.

58. The autonomous driving control apparatus according to claim 56, wherein:
the surrounding environment acquisition part acquires the surrounding environment that is a distance to an intersection present ahead of the subject vehicle; and
the driving operation determination part determines the detail and the execution time of the driving operation, based on the distance to the intersection.

59. The autonomous driving control apparatus according to claim 56, wherein:
the surrounding environment acquisition part acquires the surrounding environment that is a distance to a tunnel entrance or a tunnel exit present ahead of the subject vehicle; and
the driving operation determination part determines the detail and the execution time of the driving operation, based on the distance to the tunnel entrance or the tunnel exit.

60. The autonomous driving control apparatus according to claim 56, wherein:
the surrounding environment acquisition part acquires the surrounding environment that is a distance to an end point of an upslope present ahead of the subject vehicle; and
the driving operation determination part determines the detail and the execution time of the driving operation, based on the distance to the end point of the upslope.

61. The autonomous driving control apparatus according to claim 56, wherein:
the surrounding environment acquisition part acquires the surrounding environment that is a degree of frontward visibility from the subject vehicle, based on analysis of an image captured by an in-vehicle camera mounted on the subject vehicle; and
the driving operation determination part determines the detail and execution time of the driving operation, based on the degree of frontward visibility.

62. The autonomous driving control apparatus according to claim 37, wherein:
the driving information output part drives a seat adjustment part provided on the seat on the driver seat side of the subject vehicle in addition to the driving part of the footrest, to output the driving information.

63. The autonomous driving control apparatus according to claim 37, wherein:
the driving operation determination part determines a necessity of a warning in addition to the detail of the driving operation; and
the driving information output part vibrates the footrest portion of the footrest to issue the warning when the necessity of the warning is determined.

64. A footrest on which an occupant sitting on a seat of a subject vehicle places a foot of the occupant, the footrest comprising:
a footrest portion on which the foot of the occupant is placed; and
a driving part that shifts the footrest portion under control by the subject vehicle
wherein:
the driving part varies a frontward inclination angle, being an inclination angle of the footrest portion in a front-rear direction, in accordance with a level of acceleration or deceleration of the subject vehicle.

65. A footrest on which an occupant sitting on a seat of a subject vehicle places a foot of the occupant, the footrest comprising:
a footrest portion on which the foot of the occupant is placed; and
a driving part that shifts the footrest portion under control by the subject vehicle,
wherein:
the driving part varies a frontward inclination angle, being an inclination angle of the footrest portion in a front-rear direction, in accordance with a vehicle speed of the subject vehicle.

66. A footrest on which an occupant sitting on a seat of a subject vehicle places a foot of the occupant, the footrest comprising:
a footrest portion on which the foot of the occupant is placed; and
a driving part that shifts the footrest portion under control by the subject vehicle,
wherein:
the driving part shifts the footrest portion in accordance with either a steering angle of the subject vehicle, or acceleration in a transverse direction with respect to a traveling direction of the subject vehicle or a speed component in the transverse direction.

67. An autonomous driving control method achieving autonomous driving by controlling a driving operation of a subject vehicle, based on a situation around the subject vehicle, the autonomous driving control method comprising:
a driving operation determination step that determines a detail of the driving operation of the subject vehicle based on the situation around the subject vehicle;
a driving information output step that shifts a footrest portion of a footrest provided at a seat on a driver seat side of the subject vehicle to output the detail determined of the driving operation as driving information; and
a driving operation control step that controls the driving operation of the subject vehicle in accordance with the detail determined of the driving operation,
wherein:
the driving information output step varies a frontward inclination angle, being an inclination angle of the footrest portion in a front-rear direction, in accordance with a level of acceleration or deceleration of the subject vehicle, to output the driving information.

68. An autonomous driving control method achieving autonomous driving by controlling a driving operation of a subject vehicle, based on a situation around the subject vehicle, the autonomous driving control method comprising:
a driving operation determination step that determines a detail of the driving operation of the subject vehicle based on the situation around the subject vehicle;
a driving information output step that shifts a footrest portion of a footrest provided at a seat on a driver seat side of the subject vehicle to output the detail determined of the driving operation as driving information; and
a driving operation control step that controls the driving operation of the subject vehicle in accordance with the detail determined of the driving operation,
wherein:
the driving information output step varies a frontward inclination angle, being an inclination angle of the footrest portion in a front-rear direction, in accordance with a vehicle speed of the subject vehicle, to output the driving information.

69. An autonomous driving control method achieving autonomous driving by controlling a driving operation of a subject vehicle, based on a situation around the subject vehicle, the autonomous driving control method comprising:
a driving operation determination step that determines a detail of the driving operation of the subject vehicle based on the situation around the subject vehicle;
a driving information output step that shifts a footrest portion of a footrest provided at a seat on a driver seat side of the subject vehicle to output the detail determined of the driving operation as driving information; and
a driving operation control step that controls the driving operation of the subject vehicle in accordance with the detail determined of the driving operation,
wherein:
the driving information output step outputs the driving information that is either a steering angle of the subject vehicle, or acceleration in a transverse direction with respect to a traveling direction of the subject vehicle or a speed component in the transverse direction.

70. A driving information output method that is applied to a subject vehicle capable of performing autonomous driving based on a situation around the subject vehicle, and outputs driving information about a detail of a driving operation during the autonomous driving to an occupant of the subject vehicle, the driving information output method comprising:
a driving information acquisition step that acquires the driving information; and
a driving information output step that shifts a footrest portion of a footrest provided at a seat on a driver seat side of the subject vehicle to output the detail, which is determined, of the driving operation as the driving information,
wherein:
the driving information output step varies a frontward inclination angle, being an inclination angle of the footrest portion in a front-rear direction, in accordance with a level of acceleration or deceleration of the subject vehicle, to output the driving information.

71. A driving information output method that is applied to a subject vehicle capable of performing autonomous driving based on a situation around the subject vehicle, and outputs driving information about a detail of a driving operation during the autonomous driving to an occupant of the subject vehicle, the driving information output method comprising:
a driving information acquisition step that acquires the driving information; and
a driving information output step that shifts a footrest portion of a footrest provided at a seat on a driver seat side of the subject vehicle to output the detail, which is determined, of the driving operation as the driving information,
wherein:
the driving information output step varies a frontward inclination angle, being an inclination angle of the footrest portion in a front-rear direction, in accordance with a vehicle speed of the subject vehicle, to output the driving information.

72. A driving information output method that is applied to a subject vehicle capable of performing autonomous driving based on a situation around the subject vehicle, and outputs driving information about a detail of a driving operation during the autonomous driving to an occupant of the subject vehicle, the driving information output method comprising:
a driving information acquisition step that acquires the driving information; and
a driving information output step that shifts a footrest portion of a footrest provided at a seat on a driver seat side of the subject vehicle to output the detail, which is determined, of the driving operation as the driving information,
wherein:
the driving information output step outputs the driving information that is either a steering angle of the subject vehicle, or acceleration in a transverse direction with respect to a traveling direction of the subject vehicle or a speed component in the transverse direction.
